(19) United States
(12) Patent Application Publication
(10) Pub. No.: US 2007/0040033 A1
(43) Pub. Date: Feb. 22, 2007

(54) Digital mirror system with advanced imaging features and hands-free control

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/535,423

(22) Filed: Sep. 26, 2006

Related U.S. Application Data
(60) Provisional application No. 60/737,877, filed on Nov. 18, 2005.

(51) Int. Cl. G06K 7/10

(52) U.S. Cl. 235/462.36

(57) ABSTRACT

A digital mirror system is provided that emulates a traditional mirror by displaying real-time video imagery of a user who stands before it. The digital mirror system provides a plurality of digital mirror modes, including a traditional mirror mode and a third person mirror mode. The digital mirror system provides a plurality of digital mirroring features including an image freeze feature, an image zoom feature, and an image buffering feature. The digital mirror system provides a plurality of operational states including a digital mirroring state and an alternate state, the alternate state including a power-conservation state and/or a digital picture frame state. The digital mirror system provides a user sensor that automatically transitions between operational states in response to whether or not a user is detected before the digital mirror display screen for a period of time. The digital mirror system provides for hands-free user control using speech recognition, the speech recognition being employed to enable a user to selectively access one or more of the digital mirror modes or features in response to verbal commands relationally associated with those modes or features.

### RELATED APPLICATION DATA

This application claims priority to provisional application Ser. No. 60/737,877, filed Nov. 18, 2005, the disclosure of which is hereby incorporated by reference as if fully set forth.

### FIELD OF THE APPLICATION

The present invention relates generally to operation of a digital mirror and more particularly to operation of a wall-mounted digital mirror adapted to provide real-time images of a user in front of the digital mirror and perform other image processing techniques.

### BACKGROUND

One of the oldest pieces of technology known to humankind is the mirror. As a silvered piece of glass, the basic operation of the mirror has remained largely unchanged for thousands of years. At its core, a typical household mirror is operative to reflect an image of a user, enabling that user to view himself or herself when standing before it. Every morning, billions of people around the world look in the mirror in this way, viewing themselves as they dress, wash, brush their teeth, do their hair, put on makeup, and/or perform other common tasks. Because the mirror is so common in our lives, we take for granted that it is extremely limited in its operation. For example, a standard wall mirror as used in a typical bathroom will allow a user to view a mirror-image of himself (i.e., a left-right inverted representation of himself), but does not allow a user to view himself the way a third person standing across from him would see him (i.e., a non-inverted representation). Similarly, a standard wall mirror as used in a typical bathroom is useful for allowing a user to view himself or herself head-on, but does not enable a user to view himself from behind, or from the side. Such limitations are often frustrating, for a user may wish to see what he or she looks like from behind and/or from each profile direction. This is not possible with a standard mirror. Also, a user may with to change the magnification of a mirror in real-time, zooming and/or re-centering the reflected image. This might be useful for a user, for example, when wanting to view eyelashes or skin blemishes in close-up. This too is not possible with a standard mirror. A user may also wish to save a particular view of himself or herself as it appears in the mirror for later viewing. This is not possible with a standard mirror. A user may further wish to view multiple views of himself or herself in close proximity so that he or she can compare views. This is not possible with a standard mirror. Also a user may wish to view a current image of himself in close proximity to one or more previous images of himself to compare changes in appearance. This too is not possible with a standard mirror. Also a user may wish to perform one or more of the functions described above without needing to physically touch the mirror to make adjustments, for the user may have his hands occupied as he or she is dressing, brushing teeth, brushing hair, or performing some other manual task.

A standard mirror requires physical actions to impart any and all adjustments to the image. Thus there is a substantial need for an improved household mirror that enables greater functionality and flexibility.

Digital cameras have been used with display screens in video game applications and video phone applications. For example, U.S. Pat. No. 6,811,492, entitled “Video game machine using digital camera and digital camera accessory for video game machine,” the disclosure of which is hereby incorporated by reference, discloses a video game system that provides video phone functionality for person-to-person communication. Current video phone systems sometimes include a self-viewing mode for allowing a user to ensure that a camera is appropriate aimed prior to engaging in person-to-person video communication. Although such technology does allow for self-viewing, there is a substantial need for a significantly more versatile digital mirror system with a variety of unique and useful digital mirroring features and functions. In addition, there is a need for a hands-free user interface method and apparatus for enabling users to select and/or control the features and functions of a digital mirror. This is due to the fact that with typical household mirror usage, a user will often have his or her hands occupied with other tasks, such as brushing hair, brushing teeth, or applying makeup.

### SUMMARY

According to an embodiment of the invention, a digital mirror system is provided that has a digital mirror display to display at least one image. A camera captures the at least one image. The camera is mounted onto the digital mirror display. A hands-free sensor detects a user input. A processor controls the camera to capture the at least one image in response to the user input. The digital mirror system is adapted to provide real-time captured images that approximate what a user would see when viewing an ordinary mirror, with the addition of various other image processing features.

According to an embodiment of the invention, a method is provided that includes capturing at least one image of a user located in front of a camera mounted onto a digital mirror display. A hands-free user input is detected and the capturing is performed in response to the detecting. The at least one image is displayed on the digital mirror display. According to at least one function the at least one image is displayed substantially in real-time.

According to an embodiment of the invention, a digital mirror is provided that includes a display to display at least one image. A camera captures the at least one image. At least one hands-free sensor detects a user input. Electronics control the display and the camera in response to the user input. A housing stores the display, camera, electronics, and at the least one hands-free sensor.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a standard household wall mirror according to the prior art;

FIG. 2 illustrates a typical flat panel display according to the prior art;

FIG. 3 illustrates a wall mounted flat panel display according to at least one embodiment of the invention;

FIG. 4 illustrates a digital mirror according to at least one embodiment of the invention;

FIG. 5 illustrates a computer rendering of a human user standing in front of a wall-mounted embodiment of the advanced digital mirror system according to at least one embodiment of the present invention;

FIG. 6 illustrates a frozen digital image of a user's backside according to at least on embodiment of the invention;

FIG. 7 illustrates a frozen digital image of a user's left profile view according to at least on embodiment of the invention;

FIG. 8 illustrates a user standing before the display screen of the digital mirror system according to at least one embodiment of the invention;

FIG. 9 illustrates an exemplary display screen embodiment of such a multi-image display operation;

FIG. 10 illustrates a user standing before the digital mirror system performing a zoom-in function according to at least one embodiment of the invention;

FIG. 11 illustrates a user standing before the digital mirror system performing a zoom-out function according to at least one embodiment of the invention;

FIG. 12 illustrates a digital mirror system utilizing a zoom-guide according to at least one embodiment of the invention; and

FIG. 13 illustrates a display according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention replace the common household wall mirror with a digital mirror system that provides numerous inventive features and functions. The system employs electronic imaging hardware and software components to provide a diverse range of user-selectable mirroring capabilities to a person who stands before the wall mounted display. For example, the integrated digital mirror of the present invention enables users to quickly and easily view not only a mirror image of themselves (i.e., a left-right inverted representation) as is displayed by a traditional mirror, but also a non-inverted image of themselves (i.e. a view similar to that which a third person would see if standing across from the user at the location of the mirror). Also, the integrated digital mirror of the present invention enables users to quickly and easily view not only their frontal image when looking in the digital mirror, but also profile images and rear images. The digital mirror also enables the user to view composite images that include a concurrent display of current and previous reflective images, thereby allowing users to view changes over time in their appearance. The digital mirror further enables users to quickly and easily adjust zoom-in and zoom-out the reflective image, enabling users to focus in on particular areas of their own reflection. The digital mirror also includes unique hands-free user interface functionality in which simple vocal commands can select and adjust features and functions of the digital mirror. The digital mirror further includes a novel proximity and/or motion sensor for detecting when a user is physically present before and/or approaches and/or stands before the display screen of the mirror within some proximity range and automatically engages the digital mirror functionality of the present invention. The digital mirror also provides for dual-state operation embodiments in which the system displays digitized wall artwork or photographs when not in a mirroring mode and wherein the system automatically enters a mirroring mode when a user steps in front of the display screen for more than a threshold amount of time and/or when the user utters a particular verbal command. The digital mirror also provides for dual-state operation embodiments in which the system automatically enters a power-conservation mode, sending reduced power to the display screen when a user is not standing before the mirror for more than a threshold amount of time and wherein the system automatically enters a mirroring mode when a user steps in front of the display screen and/or when the user utters a particular verbal command.

Embodiments of the present invention replace the common household mirrors with digital embodiments that provide numerous inventive features and functions. As described herein, embodiments of the present invention provide a wall-mounted flat panel display and one or more digital camera(s) configured to provide real-time images of a user who stands before the display. In a traditional mirror mode of an embodiment of the present invention, the real-time images are streamed video images captured by a camera mounted upon the display, the real-time streamed video images being a left-right inverted representation of the video signal captured by the camera. This left-right inverted representation is generally produced by flipping the pixels of the image around the vertical centerline such that right side of the user, from the user's perspective, appears upon the right side of the display, and the left side of the user, from the user's perspective, appears upon the left side of the display. The left-right inversion process is generally performed by a processing electronics at a high rate of speed so that the left-right inverted video image of the user is presented substantially in real-time to the user (i.e., there is not a noticeable time lag for the user). This left-right inversion process is performed to present the user with a traditional mirror image view of himself or herself, inverted in a similar was as would be seen in a traditional optical mirror.

In this way the user can view his or her own image quickly and conveniently by simply stepping before the display portion of the digital mirror. In addition, embodiments of the present invention may be configured to provide a plurality of digital mirror display modes that may be selectively engaged by the user through hands-free user interactions. In a basic mode of operation, referred to herein a traditional mirror emulation mode, the digital mirror is operative to replicate the performance of a standard household mirror, providing the user with a left-right reversed frontal image of himself or herself when standing before the display. This is achieved by streaming a left-right inverted representation of the real-time video imagery from a camera aimed at the user to a screen portion of the display, the camera being mounted and aimed such that it points back at the user from a position on or near the display. In a preferred embodiment, the camera is positioned such that it is centered with respect to the screen area of the display. In basic embodiments the camera is mounted directly above the screen area of the display, generally near the center. This is non-ideal because it provides the user with a view of himself or herself from a somewhat unnatural perspective as compared to a traditional mirror. In more advanced embodiments the camera is mounted within the screen area of the display itself, approximately at eye-level of typical users, for example, positioned behind the display surface and aimed through a transparent portion of the display. Such embedded-camera embodiments provide a superior arrangement because they provide the user with a natural and accurate visual perspective of himself or herself as compared to a traditional mirror. In many such embedded-camera embodiments the camera imaging frame rate is interlaced with the display imagery frame rate such that camera images are captured during off times between the image display. Thus by mounting the camera at such a location and in such a manner, the user will get the most closely approximated mirror image captured by the camera and projected upon the display. However, embodiments which have a camera mounted above the screen area may still be configured to provide an effective image, but the vantage point will simply being slightly higher than the eye-level vantage point with which users are familiar. This raised vantage point is sometimes advantageous, giving users an increased view of the top of their head, an area that is often the focus of hair brushing.

It is often preferred to incorporate the camera within or behind the display screen because it yields a more realistic replication of a true mirror image (i.e., an image that is from a vantage point perfectly straight ahead). Such embodiments of the present invention often strive to achieve placement of the camera such that the image captured by the camera is taken from a vantage point that is centered horizontally with respect to the display screen and at an elevation vertically that generally corresponds with a user's typical eye level. In this way the user is looking straight at the camera when standing centered before the digital mirror display screen. A number of different methods and/or technologies may be employed to achieve placement of a camera such that the image captured is from this centrally located area upon the display screen. In some embodiments a small region of active screen area is removed to allow the camera to capture an image through the screen surface. This region of removed screen will generally appear as a blacked-out portion of the mirror image as if a small black dot was cut into a real mirror to allow light to pass through it. With proper optics, this dead region of the mirror display surface can be very small—for example a circular region of less than 1 millimeter in diameter. Various configurations of lenses, mirrors, and/or fiber optics can be used to enable flexibility in camera hardware positioning with respect to the small non-active portion of the screen.

In other embodiments, the camera is positioned behind the display screen and captures images through an active area of the screen during off-cycles when the digital mirror imagery is not displayed. LCD display screens are particularly well suited for such embodiments because they are transparent when not activated. Because display screens are generally controlled through a rapid sequence of active and non-active cycling, the camera may be positioned such it collects image data through an LCD display screen during the off-cycles when the LCD is not displaying an image. In some such embodiments the camera is pulsed at the same rate as the LCD display but out of phase such that the camera is operative to record images through the LCD when the LCD is transparent. A number of technologies for capturing digital images through an active display screen are disclosed in European Patent Application EP 1041506A2, the disclosure of which is hereby incorporated by reference. Such technologies may be employed with the embodiments described below to enable unique and novel digital mirror features, functions, and hardware embodiments. Although LCD display technologies are noted herein as being particularly well suited for digital mirror systems in which the camera collects images through the screen itself, other display technologies that are transparent and/or semi-transparent during part of each display cycle may be used in a similar way.

As described herein, embodiments of the present invention generally provide one or more light sources mounted at or near the display and aimed back at the user such that the frontal portion of his or her body is illuminated when standing before the display. These lights may be integrated into the casing of the display itself. These lights may be mounted directly to the wall beside the display. In some embodiments the lights are mounted behind the screen surface of the display and are operative to shine through the screen at the user. In some embodiments the lighting is a combination of the above, illuminating the user through a combination of light sources.

Embodiments of the preset invention may include one or more microphones mounted upon the display, integrated within the display, or otherwise connected to the system. The microphone feeds a speech processing module that is comprised of hardware and/or software that identifies specific vocal utterances made by the user. The speech processing features enable the user to select and/or modify various features and functions of the digital mirror without needing to press buttons, make gestures, or otherwise disrupt the manual activities being performed. For example, a user may be brushing his teeth, plucking her eyebrows, fixing his hair, or adjusting makeup and thus is busy with his or her hands and face. The speech processing interface combined with the features and functions enable a user to change modes and operations of the mirror while continuing to perform manual tasks.

Some embodiments of the present invention include one or more proximity and/or motion sensors for detecting a person located before the display screen. The proximity and/or motion sensors enable a highly valuable function in which the digital mirror can automatically turn on its display features when a person steps before it. In this way, the screen can remain off or in a low-power idle state such that when a person is not standing before the mirror, the display is not wasting power by continually displaying imagery. This auto-activation feature is generally enabled by the proximity and/or motion sensor sending data to the processor indicating that an object has come within a certain region before the display screen. There are many forms of proximity and/or motion sensors. Many operate using emitter-detector pairs. For example, in one embodiment an infra-red light source emitter emits light, aiming the emission out in front of the digital mirror display screen. An infra-red light detector is also included, detecting the level of intra-red light that is reflected back. The proximity and/or motion sensor generally operates by detecting a threshold level of reflected light and/or a certain change in the reflected light level to determine that a person is standing before the digital mirror screen. Other sensors may employ sensor means, including but not limited to ultrasonic emitters and detectors.

In addition to the auto-activation feature described above, some embodiments of the present invention employ an auto-shut-down feature where the display screen is turned off and/or switched to a low power idle mode when it is determined that a user has stepped away from the mirror for more than some threshold amount of time. Because people often move back and forth in front of bathroom mirrors, when, for example, getting dressed and going to and from a closet, the threshold amount of time is generally set long enough so that the digital mirror display screen will not turn itself off and/or enter an idle mode every time the user heads to the closet for a short time. Thus, in some embodiments the threshold amount of time for the auto-shut-down feature may be set to ten minutes. This is a configuration generally set in the software of the present invention. The processor may determine, based upon data from one or more sensors, that if a user has stepped away from the digital mirror display screen for more than ten minutes, and then the processor turns off the display screen and/or puts the display screen in a low power idle mode. In some embodiment of the present invention the user can set the threshold time used for the auto-shut-down feature in a configuration mode.

Some embodiments of the present invention allow for hands-free user activation and shut-down of the digital mirror functionality. For example, in some embodiments of the present invention the digital display screen may be active to perform the digital mirroring function when the user utters a verbal command. In the most common such embodiment, the verbal command is “mirror” or “mirror on”. Thus a user may utter the word “mirror” or “mirror on” when he or she desires to turn on the mirror functionality of the present invention. The microphone of the present invention captures the user's voice and feeds it to the speech processing module of the present invention. The speech processing module of the present invention identifies the utterance “mirror” or “mirror-on” and in response turns on the display screen and/or puts the display screen into a digital mirroring mode. The user may similarly shut-down the digital mirror functionality by uttering a verbal command. In some embodiments the verbal command is “mirror off”. The microphone captures the user's voice and feeds it to the speech processing module. The speech processing module identifies the utterance “mirror off” and in response turns off the display screen and/or causes system to end any currently active digital mirroring functionality. Other verbal commands may be used instead of or in combination with the commands above to trigger their respective functions. For example, equivalent commands in other languages may also be enabled by the speech processing module of the present invention. In some embodiments, the camera may be used alone or in combination with other sensors to provide the proximity sensing and/or motion sensing functionality.

Embodiments of the present invention, as described herein, include a processor for adjusting and/or modifying the images that are displayed upon the screen to achieve unique mirroring features and functions not provided by a standard household wall mirror. The embodiments of present invention also includes a memory accessible by the processor for storing images to further enable unique mirroring features and functions not provided by a standard household wall mirror. The processor is operative to function in coordination with the speech processing module, selecting certain features and functions in response to particular identified verbal utterances. In some embodiments the speech processing module described above includes software components that run upon the processor along with other mirroring routines running upon the processor. The processor is also operative to function in coordination with the left-right image inversion processor described previously that inverts the real-time video image from the camera into a real-time mirror image representation. In some common embodiments the same processor unit is used to support multiple of these functions, the processor unit being a single microprocessor or being a combination of a plurality of hardware and software components, including for example both programmable and hardwired processing components. As described herein the processor generally refers to the grouping of hardware and software components that perform the processing features described herein.

Embodiments of the present invention, as described herein, provide a number of unique and valuable features not provided by standard wall-mounted household mirrors. These features are provided as optional and user-selectable modes and functions that are performed in addition to the traditional mirror emulation mode. In one set of inventive features, the integrated digital mirror enables users to quickly and easily view not only left-right inverted mirror images of themselves, but also non-inverted images of themselves, the non-inverted mirror images being provided by a separate mode of the digital mirror device that may be selected by the user through hands-free interaction. The non-inverted image presentation is highly desirable because it enables a user to see what he or she looks like from the perspective of a third person standing at the location of the mirror and facing the user. Thus this non-inverted mode is referred to herein as a “third-person mirror mode.” In such a non-inverted image mode, the left side of the user (from the user's perspective) appears upon the right side of the display, and the right side of the user (from the user's perspective) appears upon the left side of the display. The third-person mirror mode is selectively enabled by the processor of the present invention by streaming non-inverted real time imagery from the camera to the digital mirror display.

In another set of inventive features, the integrated digital mirror enables users to quickly and easily view not only their frontal image, but also profile images and rear images. In fact, the user is enabled to view his or her image from any desired angle. This is performed using one of two different inventive methods. A first method is called mirror image-freeze and the second method is called mirror image-buffering. Such mirroring features may be employed during either of the traditional mirror emulation mode of the digital mirror or the third-person mirror mode of the digital mirror.

When in one of these real-time mirroring modes, the hardware and software rapidly update the image upon the display screen with a representation of the real-time digital video imagery collected from the camera. Because the camera is aimed back at the user from within, upon, or nearly upon the location of the display screen, this imagery will show a frontal depiction of any user or users who are standing substantially in front of the display screen and looking upon the screen while facing forward. In general, the rapid update rate is of a speed and lag such that it seems real-time and continuous to a human user. Typically an update rate of 60 HZ or more will be pleasing to a human user. In some embodiments update rates substantially higher than this may be used. In addition, the lag time is generally kept small (i.e., the time between image capture and image display), on the order of milliseconds or tens of milliseconds. Thus, when in a real-time mirroring mode, the image frames collected from the camera are captured at a rapid rate and displayed with minimal lag, providing a user with a real-time mirroring experience that responds in real time very much like a traditional mirror. As a user, for example, moves his arms about while brushing his or her hair, the image displayed upon the screen will appear continuously updated in real time.

When employing the mirror image-freeze feature, the user is given the ability to selectively freeze the image displayed upon the screen such that it ceases being updated for a period of time with new video imagery from the camera. Instead a previous image that was captured at the time (or nearly at the time) that the image-freeze feature was engaged is displayed for that period of time. When in a traditional mirror emulation mode, the frozen image is a left-right inverted image of the user. When in a third person mirror mode, the frozen image is a non-inverted image of the user. Thus a user may be looking in the mirror, engage the mirror image-freeze feature, and have the then current (or substantially current) image that was displayed upon engaging the feature, freeze upon the screen for an extended period. This will allow the user, for example, to examine the frozen image in detail. This is particularly useful for a user who wishes to change his or her distance and/or location with respect to the mirror to get a better view of his or her image, but NOT have the image change as the user moves. For example, a user may wish to step closer to the mirror and view a portion of his or her face from only a few inches away. With a traditional optical mirror, such an act would cause the reflected image to change such that the user who is just a few inches away ends up staring into his or her own eyes. In reality he may wish to freeze the image, step close, and then view some other portion of the face. The mirror image-freeze feature of the present invention enables this enhanced mirroring operation. It works by saving a current frame (i.e., a frame that was captured at or substantially at the time the user engaged the image freeze feature) in memory and using the stored image to update the graphical display such that the user views the frozen image over an extended period. When the user wishes to end the image-freeze function he or she may selectively end the feature and return to the real-time mirroring mode that was in operation prior to the freeze feature. In this way a real-time mirror mode will resume in which the image is continuously updated.

As described above, embodiments of the present invention employ a novel user interface method for enabling the user to engage and disengage certain mirroring feature that employs a speech recognition module. With respect to switching between a traditional mirror emulation mode to a third-person mirror mode, the user interacts with the system by uttering a particular verbal command that is recognized by the speech recognition module and triggers the software of the present invention to engage certain mode-specific software routines or operations. With respect to selectively entering and exiting the image-freeze mode, the user interacts with the system by uttering a particular verbal command that is recognized by the speech recognition module and triggers the software of the present invention to engage certain image-freeze software routines. A similar process is true of other modes and features.

The verbal command uttered by the user is generally configured to be meaningful and relevant to the particular mode, function, or feature being selectively engaged by the user through hands-free control. For example, a typical verbal command used to switch modes between the traditional mirror emulation mode and the third-person mirror mode is “flip” because the user is flipping the image left-right about a vertical centerline. Alternate words may also be used, for example “invert” or “third-person”. Similarly, a typical verbal command used to engage the image freeze feature of the present invention is “freeze.” Thus the user utters the word “freeze.” This verbal utterance is recognized by speech recognition routines. In response, image freeze software routines run which cause the displayed image to freeze upon the screen as described above. To disengage the feature, the user may utter a generic command such as “end.” In other embodiments the user will utter a more specific command such as “end freeze” or “unfreeze.” Either way, upon uttering a designated verbal utterance that is relationally associated with switching to or from a certain mode or function, the speech recognition routines identify the verbal utterance and cause the software of the present invention to respond accordingly. In the case of “unfreeze” for example, responding accordingly means ending the image-freeze feature. It should be appreciated that other words can be used to engage or disengage the above modes and feature instead of or in addition to the commands mentioned above.

As described above, the image freeze feature may be employed by a user of the digital mirror to enable this user to view himself or herself from orientations not provided by standard wall-mirrors. For example, the user may wish to view himself from behind, view himself from left profile, or view himself from right profile. When using a typical mirror, a user may turn sidewise thereby presenting his or her profile image to the mirror, but can no longer see the image because he or she is turned sideways. The same is true of the standard mirroring mode of the present invention. Thus to enable a user to view alternate angles upon himself or herself, the image freeze feature is used. The user interface of the present invention makes this a very simple operation of the user. To view himself from behind, the user simply turns around such that he or she is now facing away from the digital mirror display screen. The user then engages the image freeze feature by, for example, uttering the word “freeze,” the user then turns back around to view the mirror in a normal manner. Upon the display is a view of his or her backside. In this way a user can easily view how he or she looks from behind, examining the back of his or her head or body. To end the mode, the user may issue a command such as uttering “end freeze” and then resume viewing himself in a standard mirroring manner. To view a left profile view of himself or herself, the user can turn and face to his right such that the front plane of his body is approximately orthogonal to the mirror display screen he is standing before. He or she may engage the image freeze feature by uttering the word “freeze” or some other defined command utterance. The user then turns back toward the mirror and views it in a normal manner. Upon the display will be the user's left profile view. To end the mode, the user may issue a command such as uttering “end freeze” and then resume viewing himself in a standard mirroring manner.

To view a right profile view of himself or herself, the user can turn and face to his left such that the front plane of his body is approximately orthogonal to the mirror display screen he is standing before. He or she then engages the image freeze feature by uttering the word “freeze” or some other defined command utterance. The user then turns back toward the mirror and views it in a normal manner. Upon the display will be the user's right profile view. To end the mode, the user may issue a command such as uttering “end freeze” and then resume viewing himself in a standard mirroring manner. In addition to viewing himself or herself from behind, left profile, and right profile, other orientations may be viewed in this manner. For example, if the user wishes to view the top of his or her head—he or she can tilt over such that the top of his or her head is angled towards the display screen, engage the freeze feature, and then tilt back and look at the image from a normal viewing orientation.

When employing the mirror image-buffering feature of the present invention, the user is given the ability to selectively store a certain amount of real-time video imagery from the camera in memory and view is playing back upon the mirror. The imagery may be stored in inverted or non-inverted form. Some embodiments of the present invention are configured to continually store in memory (i.e., buffer) a certain number of recently displayed image frames. For example, if the system is capturing and displaying 100 frames per second, the system may be configured to always store the previous 1000 frames captured and displayed to the user. As new frames come in, old frames are over-written. In this way the image frame buffer maintains in memory the last 10 seconds of live imagery captured. These 1000 frames, which in this example correspond to 10 seconds of live imagery, are referred to as the “mirror image buffer.” Various embodiments of the present invention may be configured to store image buffers of different size and thereby can store differing lengths of live imagery. In this way, a portion of the buffering feature is operative in the background during real-time mirror viewing modes, background routines of the present invention continually storing some number of previous image frames.

To engage the display benefits of the mirror image-buffering feature of embodiments of the present invention, the user may utter a command such as “view buffer.” In response to this command, and/or an alternate verbal command that is defined in software to trigger this feature, routines alter the display such that the real-time imagery ceases to be displayed upon the screen for a period of time. Instead of the real-time imagery, the previously buffered camera frames are displayed, showing for example the previous 10 seconds of imagery captured by the camera and displayed upon the mirror. Thus, the user can view a previous segment of imagery that was just captured, where the previous segment is all data or a portion of the data stored in the buffer. In general, when a user is engaged in a traditional mirror mode immediately prior to the buffering feature being engaged, the buffered real-time imagery is displayed as left-right inverted representation. Similarly, when a user is engaged in a third person mirror mode immediately prior to the buffering feature being engaged, the buffered real-time imagery is display as a non-inverted representation.

As described previously, the mirror image buffering feature may be employed by a user to enable himself or herself to view himself or herself from orientations not provided by standard wall-mirrors. For example, a user may slowly turn himself around in front of a traditional mirror but will not be able to see himself during times he is not facing the mirror. Using the digital mirror with the mirror image buffering feature, however, a user can slowly turn around in front of the mirror, exposing a range of angles of his or her body to the mirror surface, and then view the stream of captured imagery right afterwards while looking directly at the screen. The user interface makes this a very simple operation of the user. To view himself while turning around in front of the mirror, the user simply turns around, for example, in a slow 360 degree spin, directly in front of the digital mirror display screen. The user then engages the mirror image buffering display feature, by for example uttering the word “replay” while looking at the screen. In response to this identified command, or other command configured to trigger the feature, the imagery displayed upon the screen is routed from the buffer and not from the live camera feed. As described previously the buffer may, for example, store the previous 10 seconds worth of video footage captured by the camera. Thus in response to the “replay” command, the previous 10 seconds of mirror display imagery is displayed to the user, showing what it looked like when he turned around in front of the mirror. The system is generally configured to continue replaying the 10 second buffer video clip, again and again, until the user explicitly ends the feature. Thus the user can watch that particular 10 second clip again and again until he or she ends the replay feature. To end the replay image buffering mode, the user may issue a command such as uttering “end replay” and then resume viewing himself in a standard mirroring manner. In some embodiments the user may just utter “end.” In some embodiments, the buffer may store some other duration than 10 seconds of previous video frames.

It should be appreciated that in some embodiments the replay feature does not display the entire contents of the image buffer, but instead displays a certain portion. For example, the image buffer may store the last 20 seconds of mirror image frames but the user may only wish to replay the last 8 seconds. Some embodiments enable this feature through a simple user interface method by which the user utters the trigger command followed by the number of seconds he wishes to replay. For example, “replay eight” or “replay eight seconds” may be uttered by the user. The speech recognition routines identify the command and words and perform the requested image buffer display. In such a case, only the previous 8 seconds of the image buffer data, and not the entire image buffer, are displayed repeatedly to the user.

In some embodiments, the digital mirror also enables the user to view a composite image upon the mirror display that includes a display of multiple images collected by the camera at different points in time. The feature, referred to herein as multi-view mirroring, allows a user to view himself or herself from multiple perspectives upon the same screen, thereby getting a more holistic impression of his or her appearance. A convenient, effective, and easy (for a user) embodiment of multi-view mirroring is enabled to allow a user to take a frozen image that was produced as a result of an image-freeze operation and/or a short video clip that was produced as a result of a image-buffering operation and move it to either the left or right side of the mirror for continuous display. In this way a user can continue to view himself in the central portion of the display through the real-time mirroring function while having saved images of himself and/or video clips of himself on the sides of the display for comparison. This is generally enabled through another set of simple voice commands such that the user can perform the function without disrupting whatever manual activity was being performed such as brushing hair or teeth. In some embodiments two verbal commands are defined as “move left” and “move right.” The system is configured in software to detect and identify these verbal utterances and in response move a frozen image or buffered video clip to the left side of the display or right side of the display respectively, freeing up the center of the display for a display standard mirroring mode. In this way, for example, a user can freeze his left profile by turning to the right and uttering “freeze.” The user then can move the frozen image to the left side of the display by uttering “move left”. The image then appears on the left side of the display and the central display resume the standard mirroring function. The user can then freeze his right profile by turning to the left and uttering “freeze”. The user can then move the frozen image to the right side of the display by uttering “move right.” The image then appears on the right side of the display and the central display again resumes the standard mirroring function. Now the user is looking in a mirror, as presented on the central portion of the digital mirror screen display, while having his left and right profiles presented on either side of the mirror. The same set of commands can be used to freeze frontal and/or rear images and present them on the left, right, or both sides of the display.

In some embodiments, multiple images can be moved to the left or right side of the display. In general any previously display images on the left or right side are reduced in size such that each image sent to that side can be displayed with generally equal size. Thus the software of the present invention may be configured to automatically reduce the size of images (or video clips) moved to the left and/or right side of the mirror display to accommodate increasing numbers of saved images (or video clips). In this way a user can freeze (or buffer) a number of images (or video clips) of himself or herself and display them along side his or her real-time mirror image on the display screen.

In some embodiments, the digital mirror also enables the user to zoom-in and/or zoom-out the real-time image that is displayed upon the screen. The feature, referred to herein as “image-zoom mirroring,” allows a user to view himself or herself from a perspective that seems nearer or farther than a typical mirror provides. Zooming in is particularly useful if a user is putting on makeup or performing some other operation that requires close attention to small details. Zooming out is particularly useful if a user wants to see a full length image of himself or herself on a mirror screen that is not naturally full-length. The zooming function may be performed by digital zoom and/or optical zoom. Digital zoom is a zoom performed by enlarging the display graphically while using an unchanged captured image. Optical zoom is a zoom performed by changing the optical focus of the camera. The present invention may employ either or both methods to modify the magnification characteristics of the digital mirror. Either way, the zooming functions are triggered by verbal commands that are correlated with zooming in or zooming out. For example, in some embodiments the verbal commands “zoom-in” and “zoom-out” are defined and associated with the zoom in and zoom out operations. The speech processor recognizes these commands and in response the routines zoom-in or zoom-out the image by some prescribed amount. For example, in some embodiments each time the user utters the command “zoom in” the mirror image is enlarged upon the display by 10%. Similarly each time the user utters the command “zoom out” the mirror image is zoomed out upon the display by 10%. Thus by repeated “zoom in” and “zoom out” verbal commands the user can achieve a desired magnification. An additional verbal command is generally included to terminate the zoom function and return the display to natural mirroring magnification. For example, verbal command “end zoom” may be used in some embodiments to achieve this function. The image zoom function may be performed by the user when in either traditional mirror emulation mode or third person mirror mode.

The user interface for verbally controlling zoom also enables the user to control the zoom-level of the display in an incremental manner, with each verbal utterance corresponding to an increasing or decreasing increment of zoom. An alternate user interface method operates differently, allowing the user to have continuous control over zoom level using verbal commands. In the continuous user interface method, upon uttering the phase “zoom in” the software begins a slow and steady increase in zoom. This will continue until either (a) maximum zoom is achieved, (b) the user utters “stop” in which case it will stop zooming in, (c) the user utters “zoom out” in which case the zoom will reverse direction, or (d) the user utters “end zoom” in which case the zoom feature will terminate and normal viewing will resume. Similarly, the user may utter “zoom out”. In response, the software routines begin a slow and steady decrease in zoom. This will continue until either (a) minimum zoom is achieved, (b) the user utters “stop” in which case it will stop zooming out, (c) the user utters “zoom in” in which case the zoom will reverse direction, or (d) the user utters “end zoom” in which case the zoom feature will terminate and normal viewing will resume.

When zooming in, it is sometimes unclear to the user where within the mirror display the zoom function is zooming in upon. For example, the user may wish to zoom in upon his ear but upon performing the zoom command may find that the image zoomed in upon his nose. This is because the zoom function generally increases the magnification towards a particular location on the screen. In some embodiments of the present invention the user may request that the location be displayed graphically to assist in his or her zooming operations. Such a graphical indicator is referred to herein as a zoom-guide. A zoom guide may be a graphical element displayed upon the screen such that it appears overlaid upon the mirror image of the user. The zoom-guide, in some embodiments, is a graphical rectangular outline that bounds the area upon the screen that the zoom function will magnify towards. In some embodiments of the present invention the user may request a zoom-guide by uttering a particular verbal command. For example, the user utters the verbal command “zoom guide” and in response a zoom guide graphical overlay is presented upon his or her projected mirror image. The zoom guide will indicate to the user what region of the screen will be zoomed in upon during a subsequent zoom operation. In some embodiments the user may issue verbal commands that move the zoom guide, including “move left,” “move right,” “move up,” and “move down”. In this way the user can control the location of the zoom-guide and thereby control where upon the mirror image is zoomed. Alternately, or in combination, the user may simply move his or her location in front of the mirror to adjust where upon his body the zoom-guide falls.

Another feature enabled by the digital mirror system is known as “image-archiving” in which images and/or video clips may be saved and stored for later retrieval. This is particularly useful for users who want to store how they look with particular hairstyles, clothing choices, and/or makeup work and review those images later. For example, a user may wish to store an image of himself or herself with his or her hair done a particular way such that the user can look at that image in the future while also looking at his or her mirror image, to assist in doing his or her hair that same way in the future. The user may also wish to archive images of himself in various outfits and look at those images while getting dressed to get ideas about what to wear. A useful element to this feature in a digital wall mirror system is the hands-free user interface through which a user can quickly and easily save a particular view of himself or herself while standing before the system. This is generally performed after a user has frozen an image upon the display that he or she wants to save the frozen image in the image archive. The image save function is triggered by a verbal command that is correlated with the saving action. The image save function may also archive the image with respect to a particular verbal utterance issued by the user. For example, in some embodiments the verbal command “save” is configured to trigger the saving action. In addition, the verbal utterance following the verbal command “save” is relationally associated with the achieved image for future access. Thus for example, a user may stand in front of the mirror, utter “freeze” and freeze an image as described previously. The user may then save the frozen image within the archive by uttering “save.” In some embodiments this image is saved based upon an automatically generated index. The automated generated index may be sequential number, a time and date, and/or an automatically generated file name. In other embodiments the user supplies an index reference by providing an additional utterance.

Some embodiments of the present invention enable the mirroring features and functions in addition to other non-mirroring functions that are operative at times when a user is not standing before the display and looking in the mirror. Thus the present invention may provide a plurality of operation states, a digital mirroring operation state in which the digital mirror display modes and features are performed and an alternate operation state in which the digital mirror display modes and features are generally not performed Such embodiments are generally implemented on non-bathroom walls of a house wherein it may not make sense to have the display simply turn itself off when a user is not present (as is usually the case in bathrooms). For example, a digital mirror of the present invention installed upon a living room wall may not be desirably configured to turn itself off when a user is not standing directly before it. Instead the digital mirror may be configured to enter a different operational state. In a common such embodiment, the digital mirror may be configured in a digital picture frame state such that it displays digital pictures including digital photographs, artwork, and/or other imagery. In such an embodiment the system is acting like a programmable picture frame when in the digital picture frame state. Unlike a traditional picture frame, a digital picture frame may be programmed to cycle through still images, including personal photos, stock artwork, and/or other stored content. Moving images may also be displayed.

Embodiments of present invention provide for a novel combination of a digital picture frame that may also be operative to function as a digital mirror. This multi-function product embodiment is configured in hardware and software to have a plurality of states, the plurality of states including (a) a first state supporting digital picture frame functionality in which stored images are accessed from memory and automatically displayed upon the screen in a manner reminiscent of a real picture frame, and (b) a second state supporting digital mirroring modes and functions and features as described herein, the digital mirroring modes and functions and features being operative to display images upon the screen that are based upon image data collected in real-time from a camera aimed at the person or persons standing before the screen at that real time and thereby replicating the function of a real mirror.

Another aspect of the multi-function product embodiments described above are the innovative methods by which the system intelligently switches between operational states. As described above, a multi-state embodiment of the present invention may include a digital picture frame state and a digital mirroring state that are operative a different moments in time. Software routines are included for automatically switching between states based upon one or more sensor readings. As described previously the system may include a proximity and/or motion sensor operative to detect if a person is standing and/or moving in an area or region in front of the display screen. The proximity and/or motion sensor, for example, may be configured to detect whether a person (or other moving option) comes within an area that extends six to eight feet in front of the screen area. Based upon the motion and/or proximity data, the routines of embodiments of the present invention may be configured to automatically switch between operational states. In a preferred embodiment of the present invention, the software routines automatically put the system into digital picture frame state when it is determined that nobody is standing and/or moving in front of the screen for more than some threshold amount of time. Thus when a counter within the electronics of the present invention determines that the threshold time has elapsed during which no presence and/or motion was detected before the display screen (as determined by data from the proximity and/or motion sensors), the system is put into a digital picture frame state. Conversely when the system is in digital picture frame state and it is determined (based upon data from the proximity and/or motion sensor data) that a person is standing before the display screen for more than some threshold amount of time (e.g., 6 seconds), the routines put the system into a digital mirroring state. In some embodiments the system enables the user to purposefully change states based upon verbal commands, in addition to and/or instead of, the automatic state changing method described above.

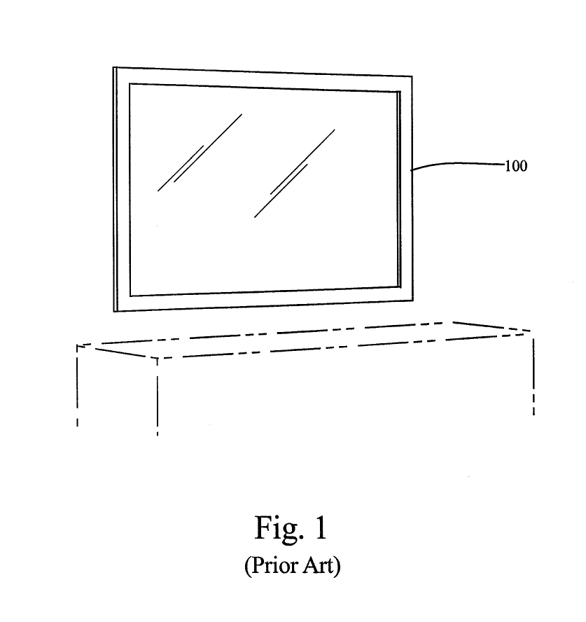

FIG. 1 illustrates a standard household wall mirror 100 according to the prior art. Every morning, billions of people around the world look in mirrors such as the standard household wall mirror 100, viewing themselves as they dress, wash, brush their teeth, do their hair, put on makeup, and/or perform other common tasks. Because the mirror 100 is so common in people's lives, they take for granted that it is extremely limited in its operation. Embodiments of the present invention provide an improved mirror that provides a range of useful and innovative features. Embodiments of the present invention, referred to herein as advanced digital mirrors, are operative to provide unique mirroring features and functions using digital imaging technology, the imaging technology including one or more digital cameras for capturing the image of a user who is standing before the invention and one or more display devices for displaying the user's image to himself or herself as he or she stands before the invention

Embodiments of the present invention also provide for a unique and versatile hands-free user interface enabling a user to control, adjust, and/or select between mirroring modes, features, and functions using verbal commands. The embodiments of present invention also provide for one or more position and/or motion sensors for detecting the presence of a person standing before the digital mirror. A unique multi-state embodiment is provided in which a digital display device acts as a digital picture frame during certain periods of time and as an advanced digital mirror during other periods of time. Embodiments of the present invention also provide for unique methods for switching between such states.

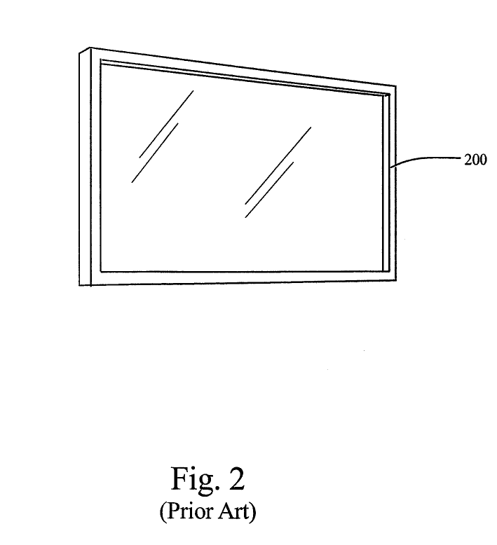

FIG. 2 illustrates a typical flat panel display 200 according to the prior art. This display 200 enables high quality digital imagery to be presented to a user from a hardware embodiment that sits upon a wall much like a traditional picture frame. In recent years flat panel display technologies have led to extremely thin monitors that can display text, video, pictures, graphics, and other digital imagery. Most current flat panel displays 200 are either LCD displays or plasma displays, although new and different display technologies continue to be developed that will enable flatter and flatter hardware to produce digital imagery with increasingly higher resolutions and enhanced fidelity. At the same time, it is expected that the cost to produce extremely thin monitors will continue to decrease, making such technologies commonplace in the home for use as televisions, computer screens, even digital picture frames that display digital photographs and/or digitized artwork upon the walls of houses and apartments.

Embodiments of the present invention may utilize thin monitors, using flat panel display technologies along with digital camera technology and a set of unique user interface methods and apparatus to provide an innovative digital hanging wall mirror for use in people's homes. As described herein, the embodiments of the present invention provide a wall-mounted flat panel display and one or more digital camera(s) configured to provide real-time images of a user standing in front of the display. In this way the user can view his or her own image quickly and conveniently by simply stepping in front of the display portion of the digital mirror.

In a basic mode of operation the digital mirror is operative to replicate the performance of a standard household mirror, providing the user with a left-right reversed frontal image of himself or herself when standing before the display 200. This is achieved by feeding a left-right inverted representation of the real-time video image from a camera aimed at the user to a screen portion of the display, the camera being mounted and aimed such that it points back at the user from a position on or near the display 200. In a preferred embodiment, the camera is positioned such that it is horizontally centered with respect to the screen area of the display 200. In basic embodiments the camera is mounted directly above the screen area of the display 200, generally near the horizontal center. In more advanced embodiments the camera is mounted within the screen area of the display 200 itself, approximately at eye-level of typical users, positioned behind the display surface and aimed through a transparent portion of the display 200. In many such embodiments the camera imaging frame rate is interlaced with the display imagery frame rate such that camera images are captured during off times between the image display 200. By mounting the camera at such a location and in such a manner, the user will get the most closely approximated mirror image captured by the camera and projected upon the display 200. By mounting the camera above the display 200, the user can capture an image from slightly above, thereby providing some view of the top of his or head. This is sometimes desirable. A camera may also be mounted at multiple elevations with respect to the display screen and can be selected between to provide for a variety of viewing angles—for example, an eye-level viewing angle that provides a highly realistic mirror replication image and a higher viewing angle that provides some view of the top of the head.

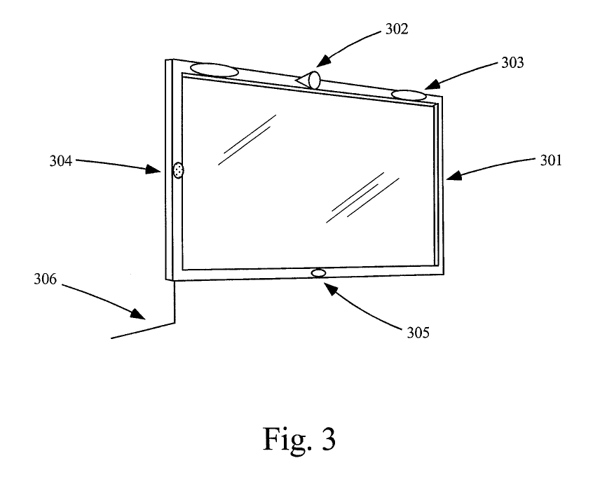

FIG. 3 illustrates a wall mounted flat panel display 301 according to at least one embodiment of the invention. As shown, a camera 302 is mounted above the screen area, integrated into the frame of the advanced digital mirror. The large flat panel display 301 may be mounted upon a wall of a user's house. The display 301 includes a screen area (darkly shaded) and a frame area (more lightly shaded). The frame area is generally a plastic casing that supports the display and supporting electronics. Also shown is the digital video camera 302 mounted upon the frame area of the display 301. The digital video camera 302 is centered horizontally across the display 301 and aimed slightly downward such that it will be pointed at any typical user that stands centered in front of the display 301 a certain number of feet back from the display 301. In general, the camera 302 is aimed such that a user can stand at a comfortable mirror-viewing distance from the display 301 and be centered within the image capture area. In some embodiments wide-angle lenses are used upon the camera 302 to provide extended image capture areas. In some embodiments auto-focus lenses are used to account for differing distances of users standing in front of the display 301.

Also shown are one or more light sources 303 mounted at or near the display 301 and aimed back at the user such that the fontal portion of his or her body is illuminated when standing before the display 301. These lights may be integrated into the frame casing of the display 301 itself. These lights sources 303 may be mounted directly to the wall beside the display 301. And in some embodiments the light sources 303 are mounted behind the screen surface of the display 301 and are operative to shine through the screen at the user. In some embodiments the lighting is a combination of the above, illuminating the user through a combination of light sources 303.

As also described herein, some embodiments of the preset invention include one or more microphones 304 mounted upon the display 301, integrated within the display 301, or otherwise connected to the system. The microphone 304 feeds a speech processing module (not shown) that is comprised of hardware and/or software that identifies specific vocal utterances made by the user. The speech processing features of embodiments of the present invention enable the user to select and/or modify various modes, features, and functions of the digital mirror without needing to press buttons, make gestures, or otherwise disrupt the manual activities being performed. For example, a user may be brushing his teeth, plucking her eyebrows, fixing her hair, or adjusting her makeup and thus is busy with her hands and face. Thus, the speech processing interface combined with the unique features and functions of embodiments of the present invention enable a user to change modes and operations of the mirror while continuing to perform manual tasks.

With respect to the speech recognition hardware and software, substantial prior-art research and development has gone into the creation of automated speech recognition systems that capture a user's voice through a microphone, digitize the audio signal, process the digitized signal, and determine the words and phrases uttered by the user. One example of such a speech recognition system is disclosed in U.S. Pat. No. 6,804,643 (“the '643 patent”), the disclosure of which is hereby incorporated by reference. As disclosed in the '643 patent, prior-art speech recognition systems consist of two main parts: a feature extraction (or front-end) stage and a pattern matching (or back-end) stage. The front-end extracts speech parameters (typically referred to as features) relevant for recognition of a speech signal. The back-end receives these features and performs the actual recognition. The task of the feature extraction front-end is to convert a real time speech signal into a parametric representation in such a way that the most important information is extracted from the speech signal. The back-end is typically based on a Hidden Markov Model (“HMM”), a statistical model that adapts to speech in such a way that the probable words or phonemes are recognized from a set of parameters corresponding to distinct states of speech.

Speech recognition of a captured speech signal typically begins with analog-to-digital-conversion, pre-emphasis and segmentation of a time-domain electrical speech signal. Pre-emphasis emphasizes the amplitude of the speech signal at such frequencies in which the amplitude is usually smaller. Segmentation segments the signal into frames, each representing a short time period, usually 20 to 30 milliseconds. The frames are either temporally overlapping or non-overlapping. The speech features are generated using these frames, often in the form of Mel-Frequency Cepstral Coefficients (“MFCCs”).

MFCCs may provide good speech recognition accuracy in situations where there is little or no background noise, but performance drops significantly in the presence of only moderate levels of noise. Several techniques exist to improve the noise robustness of speech recognition front-ends that employ the MFCC approach. So-called cepstral domain parameter normalization (“CN”) is one of the most effective techniques known to date. Methods falling into this class attempt to normalize the extracted features in such a way that certain desirable statistical properties in the cepstral domain are achieved over the entire input utterance, for example zero mean, or zero mean and unity variance.

Regardless of the actual statistical techniques used for speech processing, embodiments of the present invention generally employ a speech recognition front end and back end to enable the hands-free user interface features of the advanced digital mirror. The front end performs basic feature extraction of the utterances spoken by a user and the back-end performs pattern matching with pre-defined verbal commands to identify which of a plurality of pre-defined verbal commands the user has uttered (if any). As described herein, the pre-defined verbal commands may include words and phrases such as “mirror,” “mirror on,” “mirror off,” “zoom in,” “zoom out,” “freeze,” “save,” “move left,” “move right,” “view buffer,” “invert mirror,” “standard mirror,” “flip image”, and “end.” These and/or other pre-defined verbal commands as defined and stored in memory upon or accessible to the electronics of the advanced digital mirror and are relationally associated with certain modes, features, function, and actions to be taken by the hardware and/or software of the advanced digital mirror.

As also shown in FIG. 3, some embodiments of the present invention include one or more proximity and/or motion sensors 305 for detecting whether a person (or a similar object) is located before and/or moves before the display screen. The proximity and/or motion sensor enables valuable functions in which hardware and/or software of the digital mirror can selectively switch between a plurality of states in response to a person standing before and/or stepping before and/or stepping away from the display screen. For example, in one highly valuable feature of the present invention, the sensors 305 are used along with software routines of the present invention to automatically turn on the mirror display 301 and enable a mirroring mode of operation when a person steps before the screen area. In this way, the screen can remain off or in a low-power idle state such that when a person is not standing before the mirror, the display 301 is not wasting power by continually displaying mirroring imagery when there is nobody looking in the mirror. Thus a digital mirror in a person's bathroom can be configured only to power (or fully power) the display screen when it is detected that a person is within the bathroom. This auto-activation feature is generally enabled by the proximity and/or motion sensor sending data to the processor indicating that an object has come within a defined region before the display screen and/or motion has been detected before the display screen that meets certain magnitude and timing parameters. There are many forms of proximity and/or motion sensors. Many operate using emitter-detector pairs. For example, in one embodiment an infra-red light source emitter emits light, aiming the emission out in front of the digital mirror display screen. An infra-red light detector is also included, detecting the level of intra-red light that is reflected back. The proximity and/or motion sensor generally operates by detecting a threshold level of reflected light and/or a certain change in the reflected light level to determine that a person is standing before the digital mirror screen within some defined proximity distance. Other sensors may be used to detect if a person is standing before and/or moves before the display screen area, including but not limited to ultrasonic emitters and detectors, sound detectors, vibration detectors, digital camera, heat detectors, and/or optical detectors.

In addition to the auto-activation feature described above, some embodiments of the present invention employ an auto-shut-down feature wherein the mirroring display screen is turned off or otherwise switched a low power state when it is determined that a user has stepped away from the mirror for more than some threshold amount of time and/or if a period of time has passed wherein sufficient motion was not detected before the screen. Because people often move back and forth in front of bathroom mirrors, when for example getting dressed and therefore going too and from a closet or dresser, the threshold amount of time is generally set long enough that the digital mirror display screen will not automatically be switched to a low-power state every time the user moves away for a short amount time. Thus, in some embodiments the threshold amount of time for the auto-shut-down feature of the present invention may be set to a sufficient number of minutes, for example ten minutes. This is a configuration generally set in the software of the present invention. The processor of display 301 thus determines, based upon data from one or more sensors 305, whether or not the user has stepped away for a sufficient duration of time. If the user has stepped away from the digital mirror display screen for more than ten minutes (i.e., if the sensor data indicates that no person has come before the display's 301 screen for a period of ten minutes and/or whether the sensor has not detected sufficient motion before the display screen for a period of time minutes), the processor then turns off the display screen and/or puts the display screen in a dimmed low power state. In some embodiment of the present invention the user can set the threshold time used for the auto-shut-down feature in a configuration mode.

In some embodiments of the auto-shut down feature, two time thresholds are used in combination to determine when the mirror display should automatically switched to and from a low-power state. An “Away Threshold” is used to determine how long of a time must elapse before it is assumed that a person who had been standing in front of the mirror is now finished using the mirror. A “Use Threshold” is used to determine how long a person must spend in front of the mirror such that the person is determined to be using the mirror and not just passing by it (as a person may often do with respect to a hallway mirror). The Away Threshold may be set to a long period of time, for example, 10 minutes. The Use Threshold may be set to a much shorter period of time, for example, 5 seconds. Thus the software is configured to determine whether a user has stepped up to the mirror with an intent to use it based upon the proximity and/or motion sensor reporting data indicative of user presence that lasts for more than the Use Threshold number of seconds. Similarly, the software is configured to determine whether a user who has been using the mirror has now finished using the mirror based upon the proximity and/or motion sensor data reporting the lack of a user presence for more than the Away Threshold amount of time.

Thus if the mirror is in an low-power state and a user is suddenly detected before the mirror, but the user has not been detected for more than the Use Threshold number of seconds, the mirror will remain in the low-power state. In the event that the mirror is in a low-power state and a user has been detected before the mirror for more than the Use Threshold number of seconds, the mirror will automatically transition from the low-power state to an active digital mirroring state. If the mirror is in a digital mirroring state and proximity or motion sensor reports that the user to no longer in front of the mirror and has not been for a period of time that is longer than the Away Threshold number of minutes, the display screen is automatically switched to the low-power state. In this way a user may pass quickly before the mirror without inadvertently activating it. Similarly, a user may step away from a mirror during use for a short periods of time without inadvertently deactivating it.

Some embodiments of the present invention allow for verbal responsive switching between digital mirror states. For example, in some embodiments of the present invention the system may be configured to transition from a low-power state to a digital mirroring state in response to a verbal command. In a common such embodiment, the verbal command is “mirror” or “mirror on.” Thus a user may utter the word “mirror” or “mirror on” when he or she desires to turn on the mirror functionality. The microphone 304 captures the user's voice and feeds it to the speech processing module. The speech processing module identifies the utterance “mirror” or “mirror-on” and in response turns on the display screen and/or puts the display screen into a digital mirroring mode. The user may similarly shut-down the digital mirror functionality by uttering a verbal command. In some embodiments the verbal command is “mirror off.” The microphone 304 captures the user's voice and feeds it to the speech processing module. The speech processing module identifies the utterance “mirror off” and in response turns off the display screen and/or causes the system to end any currently active digital mirroring functionality. It should be appreciated that other verbal commands may be used instead of or in combination with the commands above to trigger their respective functions. For example, equivalent commands in other languages may also be enabled by the speech processing module. In some embodiments of the present invention the camera 302 may be used alone or in combination with other sensors 305 to provide the proximity sensing and/or motion sensing functionality.

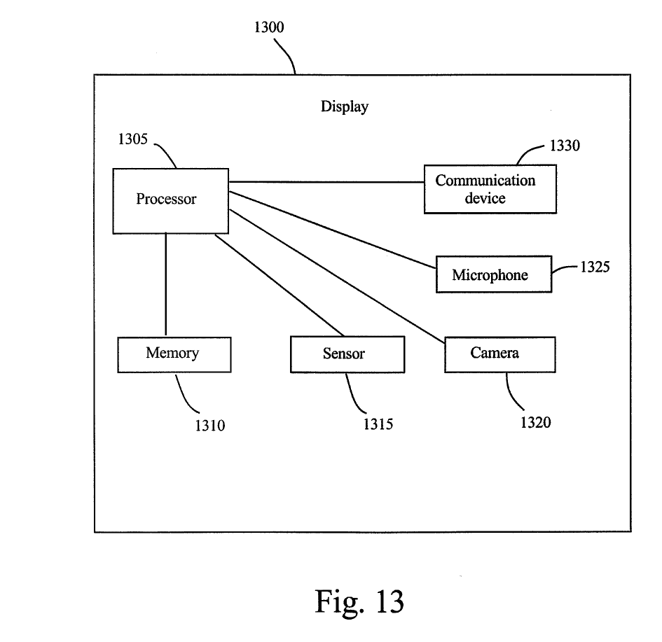

The electronics internal to the advanced digital mirror are not shown in FIG. 3 but include processing electronics, power electronics, signal conditioning electronics, and other common electronic components that may be required to support the features and functions, as discussed below with respect to FIG. 13. Embodiments of the present invention, as described herein, generally included a processor for adjusting and/or modifying the images that are displayed upon the screen to achieve unique mirroring features and functions not provided by a standard household wall mirror. Embodiments typically also include a memory accessible by the processor for storing images to further enable unique mirroring features and functions not provided by a standard household wall mirror. The processor is operative to function in coordination with the speech processing module, selecting certain modes, features, and functions in response to particular identified verbal utterances. In some embodiments the speech processing module described above includes software components that run upon the processor along with other mirroring routines running upon the processor. In addition, the processor within the advanced digital mirror may have communication access to one or more communication networks via a network connection 306.

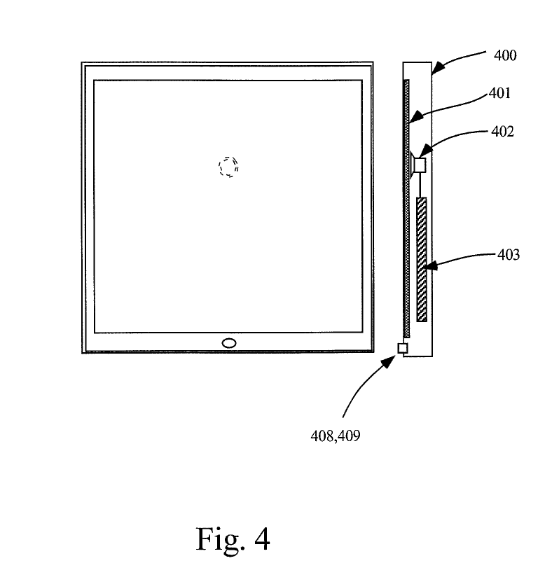

FIG. 4 illustrates a digital mirror 405 according to at least one embodiment of the invention. Unlike the embodiment shown in FIG. 3 where the camera is mounted above the display screen, the embodiment shown in FIG. 4 has a camera 402 mounted within the screen area. Such embodiments may be preferred because they yield more realistic replications of traditional mirrors because the displayed image that is from a vantage that is straight ahead. Such embodiments of the present invention often strive to achieve placement of the camera 402 such that the image captured by the camera 402 is taken from a vantage point that is centered horizontally with respect to the display screen and at an elevation vertically that generally corresponds with a user's typical eye level. In this way the user is looking straight at the camera 402 when standing centered before the digital mirror display screen. A number of different methods and/or technologies may be employed to achieve placement of a camera 402 such that the image captured is from this centrally located area upon the display screen. In some embodiments a small region of active screen area is removed to allow the camera 402 to capture an image through the screen surface. This region of removed screen will generally appear as a blacked-out portion of the mirror image as if a small black dot was cut into a real mirror to allow light to pass through it. With proper optics, this dead region of the mirror display surface can be very small—such as for example, a circular region of less than 1 millimeter in diameter. Various configurations of lenses, mirrors, and/or fiber optics can be used to enable flexibility in camera hardware positioning with respect to the small non-active portion of the screen.

Some embodiments of the present invention can be configured to capture camera imagery through the display screen without having the small dead region mentioned above. This is generally achieved by using a display technology that is transparent during a portion of each display cycle. Referring specifically to the embodiment of FIG. 4, the camera 402 is positioned behind a Liquid Crystal Display (“LCD”) screen 401 and captures images through an active area of the screen during off-cycles when the digital mirror imagery is not displayed. An LCD display screen is particularly well suited for such an embodiment because an LCD is generally transparent when not activated. Because LCD display screens are generally controlled through a rapid sequence of active and non-active cycling, the camera 402 may be positioned in the present invention such it collects image data through the LCD display screen 401 during the off-cycles when the LCD is not displaying an image. In some such embodiments the camera 402 is pulsed at the same rate as the LCD display 401 but out of phase such that the camera 402 is operative to record images through the LCD 401 when the LCD 401 is transparent. Also shown in FIG. 4 are the control and drive electronics 403 for controlling the camera 402, controlling the display, and coordinating the timing of the interlacing of camera image capture and display of imagery upon the screen. In general the electronics 403 include a processor that runs software routines, the software routines coordinating the timing of camera image capture and display cycles as described above such that the camera collects images during the off-cycles between image displays. Also shown is the housing 400 which holds the electronics, camera, display, and other components. A proximity sensor 408 and a microphone 409 may also be used as described with respect to other embodiments disclosed herein. Although LCD display technologies are noted herein as being particularly well suited for digital mirror systems in which the camera collects images through the screen itself, other display technologies that are transparent and/or semi-transparent during part of each display cycle may be used in a similar way in alternative embodiments.

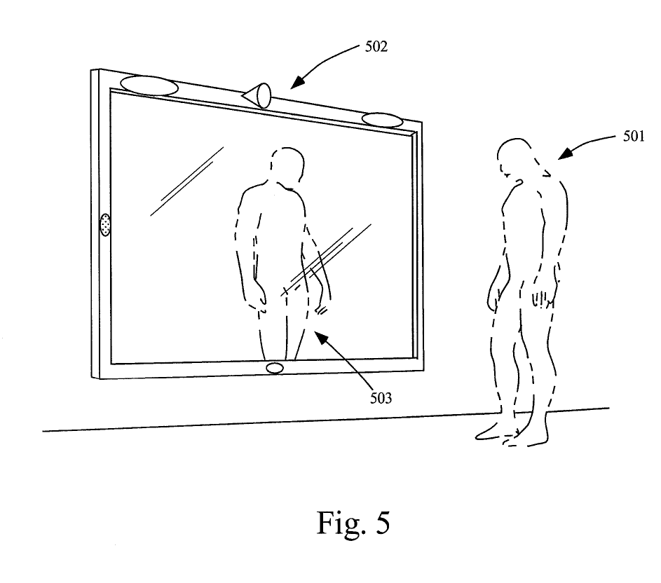

FIG. 5 illustrates a computer rendering of a human user 501 standing in front of a wall-mounted embodiment of the advanced digital mirror system 502 according to at least one embodiment of the present invention. The user's image is captured as a real-time video image by a camera upon or within the digital mirror 502 as described previously. A representation of that real-time video image is then displayed upon the wall mounted screen of the digital mirror 502 with a displayed size and scaling such that it appears like a traditional life-size mirror image 503. In a traditional mirror emulation mode, the real-time video image is left-right inverted prior to display upon the screen. Thus the user 501 standing before the digital display is given the visual impression that he or she is standing before a traditional wall mirror, viewing a traditional mirror image of himself or herself.

Embodiments of the present invention, as described herein, provide a number of unique and valuable modes and features not provided by standard wall-mounted household mirrors. These modes and features are provided as optional and user-selectable functions that are performed in addition to the traditional mirror emulating mode of the present invention.

For example, a third-person mirror mode may be provided by the hardware and software of the present invention as a user selectable option. In the third-person mirror mode, the real-time video image is not inverted prior to display upon the screen, thereby providing the user with a view of himself or herself that is similar to that which would be seen by a third person standing across from the user and facing the user. This enables a user not only to see a real-time mirror image of himself as is provided by the traditional mirror emulation mode, but also selectively access a third-person mirror mode and thereby view a real-time image of himself or herself that simulates what a third person would see. As described previously, in a common embodiment the user may selectively access and/or switch between each of the traditional mirror emulation mode and the third person mirror mode by issuing one or more particular verbal commands into the microphone of the present invention.

While performing either of the two digital mirroring modes described above, additional inventive features may be provided by the hardware and software of the present invention to further enhance the functionality of the digital mirror system. For example, the integrated digital mirror 501 of embodiments of the present invention may be configured to enable users to quickly and easily view not only their frontal image, but also profile images and rear images. In fact, a user may view his or her image from any desired angle. This is performed using one of two different inventive features. A first feature is called “mirror image-freeze” and the second inventive feature is called “mirror image-buffering.” These features are enabled in some embodiments and operate as discussed below.

When employing the mirror image-freeze feature, the user is given the ability to selectively freeze the displayed representation of the real-time video image upon the screen such that it ceases being updated with new video imagery from the camera for a period of time. Instead, a still image that represents a previous image that was captured at the time (or nearly at the time) when the image-freeze mode was engaged is displayed. Thus, a user may be looking in the mirror while using a traditional mirror emulation mode or a third person mirror mode, thereby viewing a real-time representation the video imagery captured by the camera. The user may then engage the mirror image-freeze feature, and have the then current (or substantially current) image that was displayed upon the screen, freeze upon the screen for an extended period. This will allow the user, for example, to examine the frozen image in detail. This is particularly useful for a user who wishes to change his or her distance and/or location with respect to the mirror to get a better view of his or her image, but NOT have the image change as the user moves. For example, a user may wish to step closer to the mirror and view a portion of his or her face from only a few inches away. With a traditional mirror, such an act would cause the reflected image to change such that the user who is just a few inches away ends up staring into his or her own eyes. In reality he may wish to freeze the image, step close, and then view some other portion of the face. The mirror image-freeze feature enables this enhanced mirroring operation. It works by saving a current frame (i.e., a frame that was captured at or substantially at the time the user engaged the image freeze feature) in memory and using the stored image to update the graphical display such that the user views the frozen image over an extended period. When the user wishes to end the image-freeze function he or she may selectively end the feature and return to the real-time digital mirroring mode that had been engaged prior to the freeze command being issued.

As described previously, an embodiment of the present invention employs a novel user interface method for enabling the user to engage and disengage certain mirroring modes and feature by issuing hands-free commands, the user interface method employing a speech recognition module.

In a common embodiment, the basic mode of operation is the traditional mirror emulation mode in which a left-right inverted representation of the camera imagery is streamed substantially in real-time to the mirror display screen. This mode may automatically be activated upon power-up of the unit and/or upon automatic transition from a non-mirroring state such as a digital picture frame state or a power conservation state. Once in the traditional mirror emulation mode, the user may utter one of a plurality of particular verbal commands. In response to the detection of one of a plurality of particular verbal commands, routines according to an embodiment of the present invention are configured to either switch to an alternate digital mirroring mode that is relationally associated with the particular verbal command and/or engage a particular digital mirroring feature that is relationally associated with the particular verbal command. In this way, for example, a user may utter a particular verbal command that is relationally associated with a third-person mirroring mode. In response to the detection of that particular verbal command, the routines are configured to switch to the third-person mirroring mode by streaming a non-inverted representation of the camera in substantially real-time to the mirror display screen. The verbal command uttered by the user may be, for example, “third person” or “flip” or “invert” or “flip image” or “invert mirror” or some combination thereof.

With respect to selectively engaging or disengaging the image-freeze feature, the user interacts with the system by uttering a particular verbal command that is recognized by the speech recognition module and triggers the software to engage certain image-freeze software routines. The verbal command uttered by the user is generally configured to be meaningful and relevant to the particular function. For example, a typical verbal command used to engage the image freeze feature of the present invention is “freeze.” Thus the user utters the word “freeze.” This verbal utterance is recognized by the speech recognition routines of the present invention. In response, image freeze software routines run which cause the displayed image to freeze upon the screen as described above. To disengage the feature, the user may utter a generic command such as “end.” In other embodiments the user will utter a more specific command such as “end freeze.” Either way, upon uttering a designated verbal utterance, the speech recognition routines identify the command and cause the software of the present invention to respond accordingly. In this case, responding accordingly means ending the image-freeze feature. Other words can be used to engage or disengage this feature instead of or in addition to the commands mentioned.

As described previously, the image freeze feature may be employed by a user while using one of a plurality of digital mirroring modes to enable this user to view himself or herself from orientations not provided by standard wall-mirrors. For example, the user may wish to view himself from behind, view himself from left profile, or view himself from right profile. When using a typical mirror, a user may turn sidewise thereby presenting his or her profile image to the mirror, but can no longer see the image because he or she is turned sideways. The same is true of the standard mirroring modes of the present invention. Thus to enable a user to view alternate angles upon himself or herself, the image freeze feature is used. The user interface of the present invention makes this a very simple operation of the user. To view himself from behind, the user simply turns around such that he or she is now facing away from the digital mirror display screen. The user then engaged the image freeze feature, by for example uttering the word “freeze”, the user then turns back around to view the mirror in a normal manner. Upon the display is a view of his or her backside.

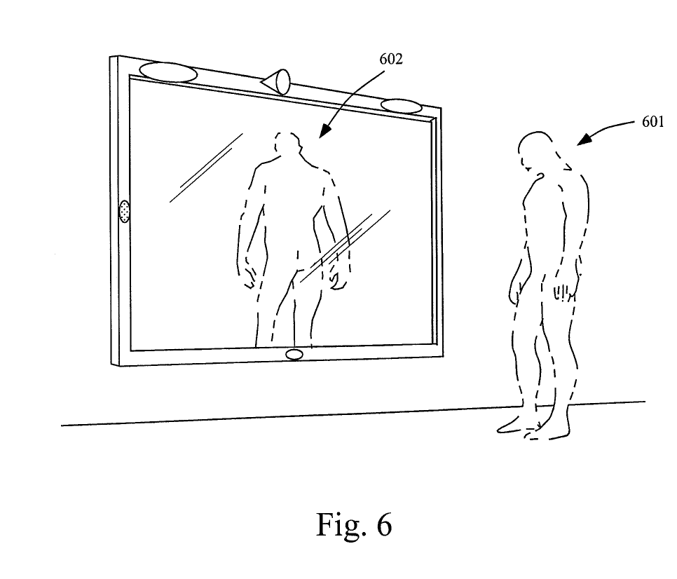

FIG. 6 illustrates a frozen digital image of a user's backside according to at least on embodiment of the invention. As shown, a user 601 has just performed the image freeze operation as described above (i.e., froze the image while having his back to the display screen). The user 601 then turns back around. Thus the user 601 is standing before the mirror and viewing a frozen image of himself 602 as viewed from behind. In this way a user 601 can easily view how he or she looks from behind, examining the back of his or her head or body. To end the mode, the user may issue a command such as uttering “end freeze” and then resume viewing himself in a standard mirroring manner.

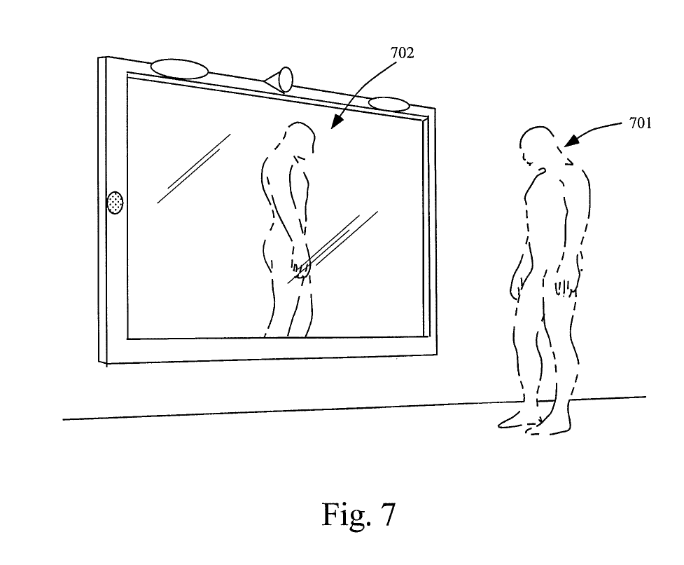

To view a left profile view of himself or herself, the user can turn and face to his right such that the front plane of his body is approximately orthogonal to the mirror display screen he is standing before. He or she then engages the image freeze feature by uttering the word “freeze” or some other defined command utterance. The user then turns back toward the mirror and views it in a normal manner. Upon the display is the user's left profile view. FIG. 7 illustrates a frozen digital image of a user's left profile view according to at least on embodiment of the invention. As shown, a user 701 has just performed the image freeze operation as described above (i.e., froze the image while having his left profile aimed at the display screen). The user 701 then turns back around. Thus the user 701 stands before the mirror and views a frozen image of himself 702 as displayed in left profile. To end the mode, the user 701 may issue a command such as uttering “end freeze” and then resume viewing himself in a standard mirroring manner.

To view a right profile view of himself or herself, the user 701 can turn and face to his left such that the front plane of his body is approximately orthogonal to the mirror display screen he is standing before. He or she then engages the image freeze feature by uttering the word “freeze” or some other defined command utterance. The user 701 then turns back toward the mirror and views it in a normal manner. Upon the display is the user's right profile view. To end the mode, the user 701 may issue a command such as uttering “end freeze” and then resume viewing himself in a standard mirroring manner. In addition to viewing himself or herself from behind, left profile, and right profile, other orientations may be viewed in this manner. For example, if the user wishes to view the top of his or her head he or she can tilt over such that the top of his or her head is angled towards the display screen, engage the freeze feature, and then tilt back and look at the image from a normal viewing orientation.

When employing the mirror image-buffering feature, the user is given the ability to selectively store a certain time duration of real-time video imagery from the camera, either left-right inverted imagery or non-inverted imagery, in memory. The user may then selectively view the stored video imagery upon the mirror at a time after the real-time capture period is complete. Some embodiments of the present invention are configured to continually store in memory (i.e., buffer) a certain number of recently displayed image frames. For example, if the system is capturing and displaying 100 frames per second, the system may be configured to always store the previous 1000 frames captured and displayed to the user. This image data is generally stored in memory local to the digital mirror system. The memory may be of any form common to art—for example, RAM with DMA access. As new frames come in, old frames are over-written. In this way the image frame buffer maintains in memory the last 10 seconds of real-time imagery. These 1000 frames, which in this example correspond to 10 seconds of live imagery, are referred to as the mirror image buffer. Various embodiments of the present invention may be configured to store image buffers of different size and thereby can store differing lengths of live imagery. In this way, a portion of the buffering feature is operative in the background during normal mirror viewing modes, background routines of the present invention continually storing some number of previous image frames.

To engage the display benefits of the mirror image-buffering feature, the user utters a command such as “view buffer.” In response to this command, and/or an alternate verbal command that is defined in software to trigger this feature, the routines of embodiments of the present invention alter the display such that the real-time imagery from the camera ceases to be displayed upon the screen for a period of time. Instead, the buffered camera frames are displayed, showing for example the previous 10 seconds of imagery captured by the camera and displayed upon the mirror. Thus the user can in this way view a previous segment of imagery that was just captured, the previous segment being all data or a portion of the data stored in the buffer.

As described previously, the mirror image buffering feature may be employed by a user of the present invention to enable himself or herself to view himself or herself from orientations not provided by standard wall-mirrors. For example, a user may slowly turn himself around in front of a traditional mirror but will not be able to see himself during times he is not facing the mirror. Using the digital mirror of the present invention, however, with the mirror image buffering feature, a user can slowly turn around in front of the mirror, exposing a range of angles of his or her body to the mirror surface, and then view the stream of captured imagery right afterwards while looking directly at the screen. The user interface of the present invention makes this a very simple operation of the user. To view himself while turning around in front of the mirror, the user simply turns around, for example, in a slow 360 degree spin, directly in front of the digital mirror display screen. The user then engages the mirror image buffering display feature, by for example uttering the word “replay” while looking at the screen. In response to this identified command, or other command configured to trigger the feature, the imagery displayed upon the screen is routed from the buffer and not from the live camera feed. As described previously the buffer may, for example, store the previous 10 seconds worth of video footage captured by the camera. Thus in response to the “replay” command, the previous 10 seconds of mirror display imagery is displayed to the user, showing him or her what it looked like when he turned around in front of the mirror. The system is generally configured to continue replaying the 10 second buffer video clip, again and again, until the user explicitly ends the feature. Thus the user can watch that particular 10 second clip again and again until he or she ends the replay feature. To end the replay image buffering mode, the user may issue a command such as uttering “end replay” and then resume viewing himself in a standard mirroring manner. In some embodiments the user may just utter “end.” In some embodiments, the buffer may store some other duration than 10 seconds of previous video frames. For example, the buffering feature could store 20 seconds of previous video frames in a particular embodiment.

In some embodiments the replay command does not display the entire contents of the image buffer, but instead displays a certain portion. For example, the image buffer may store the last 20 seconds of mirror image frames but the user may only wish to replay the last 8 seconds. Some embodiments enable this feature through a simple user interface method by which the user utters the trigger command followed by the number of previous seconds he wishes to replay. For example, “replay eight” or “replay eight seconds” may be uttered by the user. The speech recognition routines of the present invention identify the command and words and perform the requested image buffer display. In such a case, only the previous 8 seconds of the image buffer data, and not the entire image buffer, are displayed repeatedly to the user. The user ends the feature by uttering “replay end” or other defined termination command.

In some embodiments, the digital mirror also enables the user to view a composite image upon the mirror display that include a display of multiple images collected by the camera at different points in time. This feature, referred to herein as multi-view mirroring, allows a user to view himself or herself from multiple perspectives upon the same screen, thereby getting a more holistic impression of his or her appearance. A convenient, effective, and easy to user embodiment of multi-view mirroring is enabled as follows—a user may take a frozen image that was produced as a result of a mirror image-freeze operation and/or a short video clip that was produced as a result of a mirror image-buffering operation and move it to either the left or right side of the mirror for continuous display. In this way a user can continue to view himself in the central portion of the display through the real-time mirroring function while having saved images of himself and/or video clips of himself on the sides of the display for comparison. This is generally enabled through another set of voice commands such that the user can perform the function without disrupting whatever manual activity was being performed such as brushing hair or teeth. In some embodiments two verbal commands are defined as “move left” and “move right.” The system is configured in software to detect and identify these verbal utterances and in response move a frozen image or buffered video clip to the left side of the display or right side of the display respectively, freeing up the center of the display for a display standard mirroring mode. In this way, for example, a user can freeze his left profile by turning to the right and uttering “freeze.” The user then can move the frozen image to the left side of the display by uttering “move left.” The image then appears on the left side of the display and the central display resume the standard mirroring function. The user can then freeze his right profile by turning to the left and uttering “freeze.” The user can then move the frozen image to the right side of the display by uttering “move right.” The image then appears on the right side of the display and the central display again resumes the standard mirroring function.

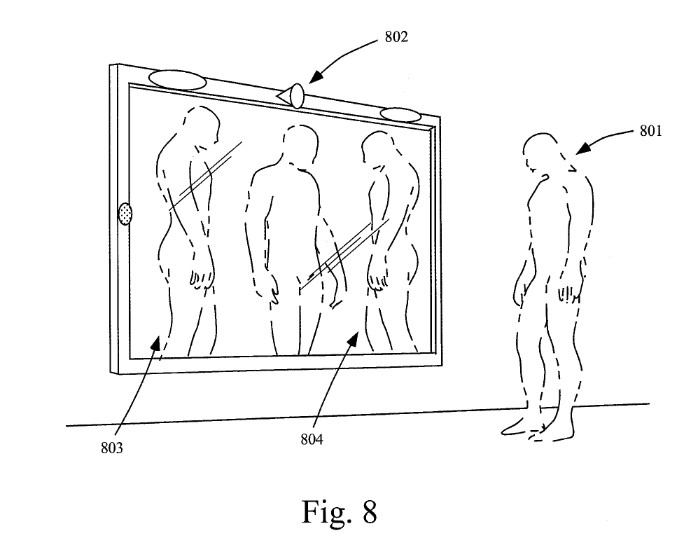

The results of such an operation are shown in FIG. 8 herein. FIG. 8 illustrates a user 801 standing before the display screen of the digital mirror system according to at least one embodiment of the invention. In the center of the display, a real-time mirror image 802 is generated and displayed. On the left side of the display is a frozen left profile image 803 of the user 801 as captured during a previous “image freeze” command and put on the left side of the display by a previous “move left” command. On the right side of the display is a frozen right profile image 804 of the user as captured during a previous “image freeze” command and put on the right side of the display by a previous “move right” command. Thus with a few simple hands free commands, the user 801 can cause the processor to compose and display a valuable composite image display. In some embodiments the user may choose to put the right profile on the left side of the display and vice versa.

Thus as shown in FIG. 8, the user 801 is looking in a mirror, as presented on the central portion of the digital mirror screen display, while having his left and right profiles presented on either side of the mirror. The same set of commands can be used to freeze frontal and/or rear images and present them on the left, right, or both sides of the display.

In some embodiments, multiple images can be moved to either the left or right side of the display. The software of the present invention is configured to display the multiple images by reducing the size of each to accommodate the multi-image display. For example, if two images are sent to the left side of the display by the user, the software of the present invention will reduce each image to half size upon display. If the user sends three images to the left side of the display, the software according to some embodiments of the preset invention will reduce each image to one-third size upon display. In general, the software may be configured to display any number of images on either the left or right side of the display (within some maximum limit) by reducing the size of each displayed image such that each image sent to that side can be displayed with generally equal size.

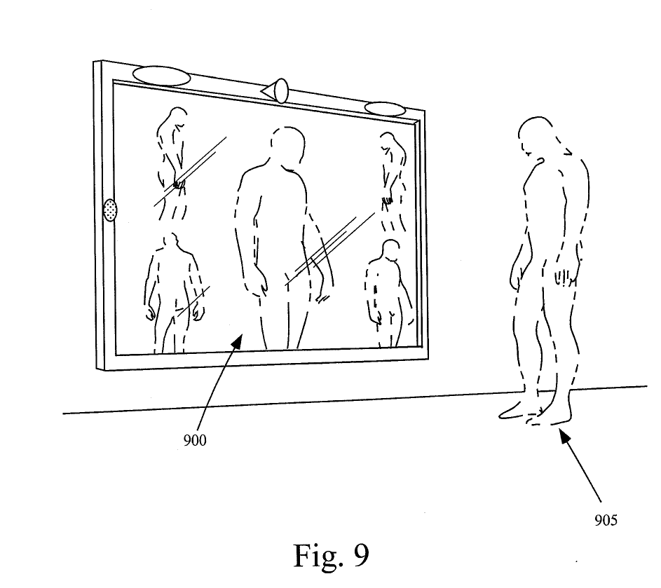

FIG. 9 illustrates an exemplary display screen 900 embodiment of such a multi-image display operation. In this particular embodiment the user 905 has sent two frozen images to the left side of the display by using two sequential image freeze and image move commands. The user has also sent two frozen images to the right side of the display using two sequential image freeze and image move commands. The software according to this embodiment of the invention may display all four frozen images, each one reduced to approximately half-size, to accommodate the multiple images. In this way the user 905 can freeze and display a plurality of images of himself or herself, all displayed simultaneously with the real-time mirror image which is displayed at the center of the display screen.

If the user moves four images to the left side of the display using the image freeze and “move left” commands four consecutive times, each of the four images would be displayed on the left side of the display, each at about quarter-size. Thus the software according to embodiments of the present invention may be configured to automatically reduce the size of images (or video clips) moved to the left and/or right side of the mirror display to accommodate increasing numbers of saved images (or video clips). In this way a user can freeze (or buffer) a number of images (or video clips) of himself or herself and display them along side his or her real-time mirror image on the display screen. Alternate or additional verbal utterances can be used to trigger the move-left and move-right commands described above so long as those commands are defined in software and associated with the respective commands.

In some embodiments, the digital mirror also enables the user to zoom-in and/or zoom-out the real-time mirror image that is displayed upon the screen. The zoom feature may be engaged while in a traditional mirror emulation mode or while in a third person mirror mode. The feature, referred to herein as image-zoom mirroring, allows a user to view himself or herself from a perspective that seems nearer or farther than a typical mirror provides. Zooming in is particularly useful if a user is putting on makeup or performing some other action that requires close attention to small details. Zooming out is particularly useful if a user wants to see a full length image of himself or herself on a mirror screen that is not naturally full-length. Such zooming in and zooming out functions make the current digital mirror system substantially improved over traditional wall mirrors for it allows a single mirror to be used for close-up actions that require magnification, life-size actions that are performed in front of standard mirrors, and full length views that are often not possible in small spaces. In addition, the actions usually performed by users when looking at close up or full length views usually require use of the hands and so the unique hands-free mirror controlling interface as disclosed herein is particularly well adapted.

The zooming in and zooming out functions of the present invention may be performed by digital zoom and/or optical zoom. Digital zoom is a zoom performed by enlarging the display graphically without changing the optics of the camera in the image capture process. Optical zoom is a zoom performed by changing the optical focus of the camera by adjusting lenses using automated means known to the art. The present invention may employ either or both methods to modify the magnification characteristics of the digital mirror. Either way, the zooming functions are triggered by verbal commands that are correlated with zooming in or zooming out. For example, in some embodiments the verbal commands “zoom-in” and “zoom-out” are defined and associated with the zoom in and zoom out operations. A speech processor recognizes these commands. In response the routines of the present invention zoom-in or zoom-out the image by some prescribed amount. For example, in some embodiments each time the user utters the command “zoom in” the mirror image is enlarged upon the display by 10%. Similarly each time the user utters the command “zoom out” the mirror image is zoomed out upon the display by 10%. Thus by repeated “zoom in” and “zoom out” verbal commands the user can achieve a desired magnification. An additional verbal command is generally included to terminate the zoom function and return the display to natural mirroring magnification. For example, verbal command “end zoom” may be used in some embodiments to achieve this function.

The above user interface for verbally controlling zoom enables the user to control the zoom-level of the mirror in an incremental manner, each utterance corresponding to an increasing or decreasing increment of zoom. An alternate user interface method operates differently, allowing the user to have continuous control over zoom level using verbal commands. In the continuous user interface method, upon uttering the phase “zoom in” the software of the present invention begins a slow and steady increase in zoom. This will continue until either (a) maximum zoom is achieved, (b) the user utters “stop” in which case it will stop zooming in, (c) the user utters “zoom out” in which case the zoom will reverse direction, or (d) the user utters “end zoom” in which case the zoom feature will terminate and normal viewing will resume. Similarly, the user may utter “zoom out”. In response, the software routines of the present invention begins a slow and steady decrease in zoom. This will continue until either (a) minimum zoom is achieved, (b) the user utters “stop” in which case it will stop zooming out, (c) the user utters “zoom in” in which case the zoom will reverse direction, or (d) the user utters “end zoom” in which case the zoom feature will terminate and normal viewing will resume.

Alternate or additional utterances may be used to trigger and/or control the zoom-in, zoom-out, and end-zoom functions described above so long as those verbal utterances are defined in software and associated with the respective functions. In some embodiments the user may utter a percentage amount by which to perform a zoom. For example the user may utter “zoom in fifty percent.” The speech recognition system will interpret the words and in response perform a zoom in function by 150%. For embodiments that support large amounts of zoom, the user may indicate the number of times (factors of 100%) that he or she desires the zoom. For example the user may utter “zoom in four times.” The speech recognition system of the present invention will interpret the words and in response perform a zoom in function by 400%.

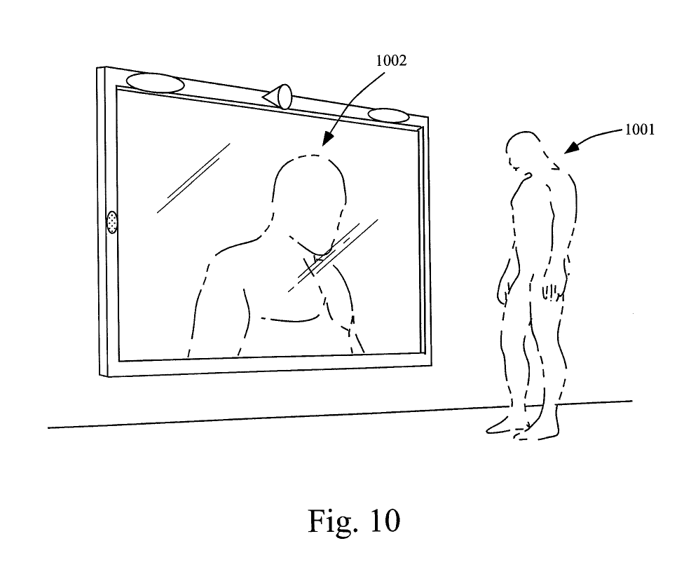

FIG. 10 illustrates a user 1001 standing before the digital mirror system performing a zoom-in function according to at least one embodiment of the invention. The user 1001 has performed a zoom-in function by uttering one or more appropriate verbal commands. For example the user 1001 may have uttered “zoom in three times.” In response the software performs a digital and/or optical zoom upon the input image and displays the resulting zoomed video stream in real-time. Thus the user 1001 views a real-time video stream of himself, now zoomed by 300%. Such an image is shown as an example in FIG. 10, the zoomed image 1002 depicting the user in real-time, only larger.

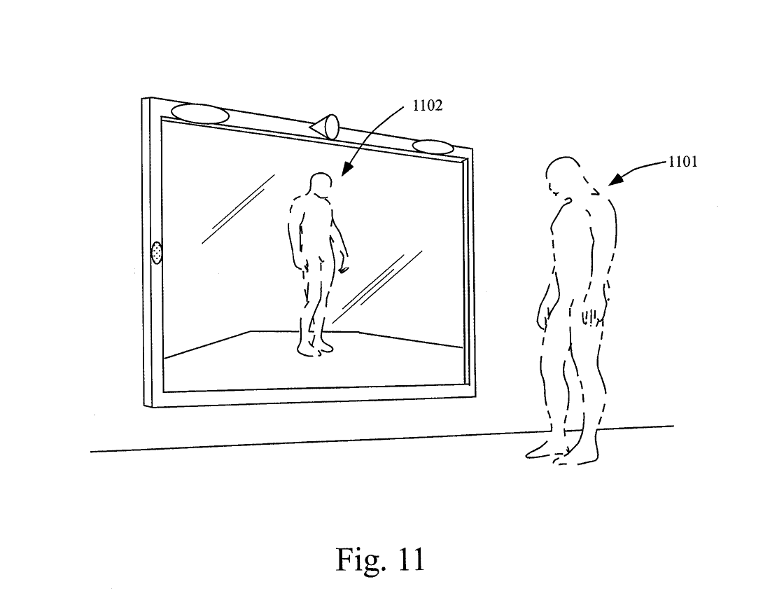

FIG. 11 illustrates a user 1101 standing before the digital mirror system performing a zoom-out function according to at least one embodiment of the invention. The user 1101 has performed a zoom-out function by uttering one or more appropriate verbal commands. For example the user may have uttered “zoom out two times.” In response the software of the present invention performs a digital and/or optical zoom upon the input image and displays the resulting zoomed video stream in real-time. Thus the user 1101 views a real-time video stream of himself, now reduced (zoomed out) by 50%. Such an image is shown as an example in FIG. 11, the zoomed-out image 1102 depicting the user in real-time, only smaller. In this way the user 1101 can view a full length view of himself, not something provided by a standard (un-zoomed) mirror image.

When zooming in, it is sometimes unclear to the user 1101 where within the displayed image the zoom function will zoom in upon. For example, the user 1101 may wish to zoom in upon his ear but upon performing the zoom command may find that the image zoomed in upon his nose. This is because the zoom function generally increases the magnification towards a particular location on the screen. In some embodiments of the present invention the user 1101 may request that the zoom target location be displayed graphically to assist in his or her zooming operations. Such a graphical indicator is referred to herein as a zoom-guide. A zoom guide may be a graphical element displayed upon the screen such that it appears overlaid upon the mirror image of the user. The zoom-guide, in some embodiments, is a graphical rectangular outline that bounds the area upon the screen that the zoom function will magnify towards.

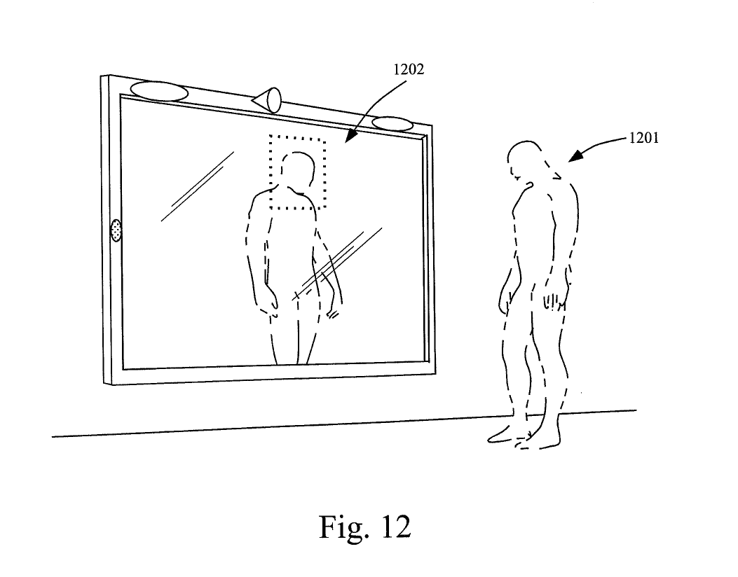

FIG. 12 illustrates a digital mirror system utilizing a zoom-guide according to at least one embodiment of the invention. As shown, a graphical image is overlaid upon the captured real-time video image display from the camera. Thus the user 1201 can view a real-time mirror image upon the display screen and at the same time have the graphical overlay displayed upon it. Thus as shown in FIG. 12, the user 1201 stands before the display screen of the digital mirror. His or her real-time image is displayed back to him upon the screen. In addition a graphical overlay zoom guide 1202 is displayed upon the real-time video image thereby showing the user where upon the screen the image may zoom towards or two upon a zoom command.

In some embodiments of the present invention the user may request a zoom-guide by uttering a particular verbal command. For example, in some embodiments of the present invention the user utters the verbal command “zoom guide” and in response a zoom guide graphical overlay is presented upon his or her projected mirror image. The zoom guide will indicate to the user what region of the screen will be zoomed towards or upon during a subsequent zoom operation. In some embodiments of the present invention the user may issue verbal commands that move the zoom guide, including “move left,” “move right,” “move up,” and “move down.” In this way the user can control the location of the zoom-guide and thereby control where upon the mirror image is zoomed. Alternately, or in combination, the user may simply move his or her location in front of the mirror to adjust where upon his body the zoom-guide falls. In some embodiments the user may control the size of the zoom guide by uttering verbal commands such as “larger” and/or “smaller” to achieve that effect respectively.

Another feature enabled by the digital mirror system of embodiments of the present invention is known as image-archiving in which images and/or video clips may be saved and stored for later retrieval. This is particularly useful for users who want to store how they look with particular hairstyles, clothing choices, and/or makeup work and review those images later. For example, a user may wish to store an image of himself or herself with his or her hair done a particular way such that the user can look at that image in the future while also looking at his or her mirror image, to assist in doing his or her hair that same way in the future. The user may also wish to achieve images of himself or herself in various outfits and look at those images while getting dressed to get ideas about what to wear. The key to this feature in a digital wall mirror system is the hands-free user interface through which a user can quickly and easily save a particular view of himself or herself while standing before the system. This is generally performed after a user has frozen an image upon the display that he or she wants to save the frozen image in the image archive. The image save function is triggered by a verbal command that is correlated with the saving action. The image save function may also archive the image with respect to a particular verbal utterance issued by the user. For example, in some embodiments the verbal command “save” is configured to trigger the saving action. In addition, the verbal utterance following the verbal command “save” is relationally associated with the achieved image for future access. Thus for example, a user may stand in front of the mirror, utter “freeze” and freeze an image as described previously. The user may then save the frozen image within the archive by uttering “save.” In some embodiments this image is saved based upon an automatically generated index. The automated generated index may be sequential number, a time and date, and/or an automatically generated file name. In other embodiments the user supplies an index reference by providing an additional utterance. For example, the user may utter “red dress one” and thereby save the image, indexed with respect to the utterance “red dress one.”

FIG. 13 illustrates a display 1300 according to at least one embodiment of the invention. As shown, the display 1300 includes a processor 1305, a memory 1310, a sensor 1315, a camera 1320, a microphone 1325, and a communication device 1330. The display 1300 displays the digital images. The processor 1305 is in communication with the display screen 1300, the microphone 1325, the camera 1320, the sensor(s) 1315, and the memory 1310. The processor 1305 receives data from the microphone 1325, the camera 1320, and the sensor 1315, and controls the various components of the display 1300. The processor may be a single microprocessor unit or may comprise a plurality of processing components that share the processing burden. The memory 1310 may store program code to be executed by the processor 1305, as well as archived images. The sensor 1310 senses various user inputs, such as the user walking in front of the display screen or stepping before the display screen. The sensor may comprise a dedicated motion sensor or proximity sensor. In some embodiments the sensor functions are achieved at least in part using camera 1320. The user's spoken voice is detected by the microphone 1325. The communication device 1330 is utilized to receive and transmit images across a network. The processor may be operative to enable a plurality of different operating states of the unit, including a digital mirroring state, a power conservation state, and/or a digital picture frame state, as described previously.

A user of the present invention may also access stored images by uttering verbal command such as “load” or “show.” For example, the user may utter the phrase “load red dress one.” The software of the present invention is operative in response to such a command to access the image that is relationally associated with the verbal identifier “red dress one” and will display it upon the screen. The user may move that image to a side of the screen using a command described previously such as “move left” or “move right.” Upon uttering “move left,” for example—the saved frozen image is moved to the left side of the display and the user's real-time mirror image then resumes being displayed in the center of the screen. In this way the user can view himself or herself in the center of the display and compare his image with the old image that was accessed from the archive memory. In this way a user can, for example, access an old image while doing his or her hair and thereby adjust his or her hair in real time until it matches some previous photo that he or she wants to replicate.

Some embodiments of the present invention provide a stock library of human images taken of models or celebrities having a variety of hair styles. A user may access and display a stock image in order to assist himself or herself in doing his or her own hair by copying look of the model or celebrity. For example a user may access a stock image of a woman wearing braids from a library of images accessible to the processor of the present invention, display that image upon the screen, move the image to the side of the display, and then view the image at the same time as the real-time mirror image footage that is displayed at the center of the screen. In this way a user can adjust her hair in the mirror to match the stock image showing a desirable hairstyle. In some embodiments the stock hairstyle images are computer generated renderings and not photographs. In some embodiments the stock hairstyle images may be presented in the center of the display simultaneously with the real-time mirror image of the user also displayed at the center of the screen, the stock hairstyle image being graphically overlaid as an onionskin transparency upon the real-time image of the user himself or herself.

Some embodiments of the present invention enable the mirroring features and functions in addition to other non-mirroring states that are operative at times when a user is not standing before the display and looking in the mirror. Such embodiments are generally implemented on non-bathroom walls of a house wherein it may not make sense to have the display simply turn itself off when a user is not present (as is usually the case in bathrooms). For example, a digital mirror of the present invention installed upon a living room wall may not be configured to turn itself off when a user is not standing directly before it. Instead the digital mirror may be configured to enter a different operational state. In a common such embodiment, the digital mirror may be configured in a digital picture frame state such that it displays digital pictures including digital photographs, artwork, and/or other imagery. In such an embodiment the system is acting like a programmable picture frame when in the digital picture frame mode. Unlike a traditional picture frame, a digital picture frame may be programmed to cycle through still images, including personal photos, stock artwork, and/or other stored content. Moving images may also be displayed. Digital picture frame products and technologies are known to the art as disclosed in U.S. Pat. No. 6,442,573, the disclosure of which is hereby incorporated by reference. Digital picture frame technologies are also disclosed in U.S. Pat. No. 6,535,139, the disclose of which is also hereby incorporated by reference. Digital picture frame technologies are further disclosed in U.S. Patent Application Publication No. 2005/0012758, the disclosure of which is hereby incorporated by reference. Digital picture frame technologies are also disclosed in U.S. Patent Application Publication No. 2002/0126150, the disclosure of which is also hereby incorporated by reference.

While digital picture frames are not new the art, embodiments of the present invention provide for a novel combination of a digital picture frame that may also be operative to function as a digital mirror. This multi-function product embodiment that is configured in hardware and software to have a plurality of states, the plurality of states including (a) a first state supporting digital picture frame functionality in which stored images are accessed from memory and automatically displayed upon the screen in a manner reminiscent of a real picture frame, and (b) a second state supporting digital mirroring functions and features as described herein, the digital mirroring functions and features being operative to display images upon the screen that are based upon image data collected in real-time from a camera aimed at the person or persons standing before the screen at that real time and thereby replicating the function of a real mirror.

Another novel aspect of the multi-function product embodiments described above are the innovative methods by which the system intelligently switches between states. As described above, a multi-function embodiment of the present invention may include a digital picture frame state and a digital mirroring state that are operative a different moments in time. The present invention also includes software routines for automatically switching between states based upon one or more sensor readings. As described previously the present invention may include a proximity and/or motion sensor operative to detect if a person is standing and/or moving in an area or region in front of the display screen. The proximity and/or motion sensor, for example, may be configured to detect if a person (or other moving object) comes within an area that extends, for example, six to eight feet in front of the screen area. Based upon the motion and/or proximity data, routines of the present invention may be configured to automatically switch between operational states. In a preferred embodiment of the present invention, the software routines automatically put the system into digital picture frame state when it is determined that nobody is standing and/or moving in front of the screen for more than some threshold amount of time. In one such embodiment the threshold amount of time is 300 seconds. Thus when a counter within the electronics of the present invention determines that 300 seconds have elapsed during which time no presence and/or motion was detected in a particular area before the display screen (as determined by data from the proximity and/or motion sensors), the system is put into a digital picture frame state. Conversely when the system is in digital picture frame state and it is determined (based upon data from the proximity and/or motion sensor data) that a person is standing before the display screen for more than some threshold amount of time (for example, 6 seconds), the routines of the present invention put the system into a digital mirroring state. A threshold amount of time is used to ensure that the system does not shift into digital mirroring state by virtue of a person just walking past the display screen. Instead the inventive method of the present invention is configured to determine that the person is present in front of the display screen for more than some threshold amount of time (for example, 6 seconds), thereby assuring that only a person who stops and looks in the mirror from a particular area directly before it, will trigger the system to enter digital mirroring state.

In some embodiments of the present invention the system enables the user to purposefully change states based upon verbal commands, in addition to and/or instead of, the automatic state changing method described above. For example, the user may utter the phase “mirror” or “mirror on” (as described previously) to enter the digital mirroring state. Similarly the user may utter the phase “end mirror” or “mirror off” to turn off the mirror and return the system to a digital picture frame state. In this way if a user steps in front of a displayed piece of art work to admire the art work and the system shifts into mirror state at a time when the user did not want a mirror, the user need only utter “end mirror” or “mirror off” to return to the displayed artwork state. In such an embodiment the automatic routines are configured to be intelligent with respect to the user's purposeful command. The routines will not again display the mirror after 6 seconds, but will be smart, knowing that if the user terminated the mirror command, he or she is unlikely to want it turned on every 6 seconds while standing there. To address this issue, the system is often configured upon a user override command, not to turn on a mirror unless (as determined by the proximity sensors and/or motion sensors) the user first walks away for some threshold amount of time, before returning then triggering the mirror again.

An additional feature enabled by at least one embodiment of the present invention is a lighting emulation feature in which well known image processing techniques are used upon the real-time video imagery to alter the natural lighting conditions of the imagery to that of a simulated lighting condition. For example, image processing routines may be employed to alter the real-time video image such that the displayed lighting conditions simulate one of natural light, florescent light, or incandescent light. In this way a user may selectively view himself or herself in lighting conditions other than that which are present in the area of the digital mirror system. Particular verbal commands are relationally associated with each simulated lighting condition thus enabling a hands-free control of the lighting emulation features. For example verbal commands such as “natural light”, “florescent light” and “incandescent light” may be relationally associated with simulations of natural lighting conditions, florescent lighting conditions, and incandescent lighting conditions, respectively.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided.

While the invention herein disclosed has been described by means of specific embodiments and applications thereof, numerous modifications and variations could be made thereto by those skilled in the art without departing from the scope of the invention set forth in the claims.

1. A digital mirror system, comprising:
a digital mirror display screen;
a digital camera affixed to the digital mirror display screen at a location and orientation such that the digital camera captures real-time video imagery of a user positioned proximally before a display surface of the digital mirror display screen;
a microphone for capturing voice input from the user proximal to the digital mirror display screen;
a processor connected to the digital mirror display screen, the digital camera, and the microphone, wherein the processor is operative to cause a representation of the real-time video imagery captured by the digital camera to be displayed upon the digital mirror display screen, the processor being programmed to enable a plurality of selectively enabled digital mirror display modes, the digital mirror display modes comprising:
a traditional mirror emulation mode, wherein the traditional mirror emulation mode is generated by streaming a left-right inverted representation of the real-time video imagery to the digital mirror display screen, the traditional mirror emulation mode providing the user with a mirror-image view of the user;
a third person mirror mode, wherein the third person mirror mode is generated by streaming a non-inverted representation of the real-time video image to the digital mirror display screen, the third person mirror mode providing the user with a third-person view of the user;
a hands-free mirror-control routine implemented by the processor that switches from the traditional mirror emulation mode to the third person mirror mode in response to certain verbal input being issued to the microphone by the user.

2. The digital mirror system of claim 1 wherein the certain verbal input is a verbal command relationally associated with the third person mirror mode.

3. The digital mirror system of claim 1 wherein the processor is further operative to switch from the third person mirror mode to the traditional mirror emulation mode in response to a different certain verbal input being issued to the microphone, the different certain verbal input being a different verbal command uttered by the user.

4. The digital mirror system of claim 1 wherein the processor is further operative to selectively engage, in response to a related verbal command from the user, an image freeze feature wherein the processor freezes the digital mirror display screen of the streaming representation of the real-time video imagery such that a still image that is derived from the real-time video imagery is displayed upon the digital mirror display screen during the image freeze mode.

5. The digital mirror system of claim 4 wherein the processor is further operative to end the image freeze mode in response to a different verbal command being issued to the microphone.

6. The digital mirror system of claim 1 wherein the processor is further operative to selectively engage, in response to a related verbal command from the user, a zoom feature in which the processor enlarges at least a portion of the representation of the real-time video imagery that is displayed upon the digital mirror display screen.

7. The digital mirror system of claim 1, wherein the processor is further operative to selectively engage, in response to a related verbal command from the user, a simulated lighting feature in which a simulated lighting condition is applied to the representation of the streaming real-time video imagery, the simulated lighting condition being applied so as to emulate upon the digital mirror display screen the user's appearance under at least one of natural light, incandescent light, and florescent light conditions.

8. The digital mirror system of claim 1 wherein the digital camera is mounted within the display surface of the digital mirror display screen.

9. The digital mirror system of claim 8 wherein the digital camera is mounted at a location within the display surface that approximately corresponds with eye-level of a typical user.

10. The digital mirror system of claim 1 wherein the digital camera is mounted behind the digital mirror display screen such that the digital camera captures the real-time video imagery of the user by collecting light through a plane of the digital mirror display screen.

11. The digital mirror system of claim 1 wherein the digital mirror display screen is mounted on a wall of a structure at a height level determined to be convenient for the user to stand near.

12. The digital mirror system of claim 1, further comprising a communication device to receive data over a network.

13. The digital mirror system of claim 1, wherein the processor is further operative to implement a power-conservation state in which power to the digital mirror display screen is reduced.

14. The digital mirror system of claim 1, wherein the processor is further operative to implement a digital picture frame state to cause at least one pre-stored digital image accessed from a memory to be displayed upon the digital mirror display screen.

15. The digital mirror system of claim 13, wherein the processor is further operative to perform an automatic state selection function in response to determining whether the user is detected in front of the digital mirror display screen, the automatic state selection function including at least a first state and a second state,
the first state comprising a digital mirror state in which a representation of the real-time video imagery is presented upon the digital mirror display screen;
a second state comprising a power-conservation state; and wherein
the first state is enabled in response to a detection of the user in front of the digital mirror display screen, and the second state being enabled in response to the user not being detected in front of the digital mirror display screen.

16. The digital mirror system of claim 14 wherein the processor is further operative to perform an automatic state selection function in response to determining whether the user is detected before the digital mirror display screen, the automatic state selection function including at least a first state and a second state,
the first state comprising a digital mirror state in which a representation of the real-time video imagery is presented upon the digital mirror display screen,
the second state comprising a digital picture frame state, and wherein
the first state is enabled in response to a detection of the user in front of the digital mirror display, and the second state being enabled in response to the user not being detected in front of the digital mirror display.

17. The digital mirror system of claim 16 wherein the processor is further operative to change from the digital picture frame state to the digital mirroring state in response to the user being detected in front of the digital mirror display screen for more than a threshold amount of time.

18. The digital mirror system of claim 15 wherein the mode is changed from the digital mirroring state to the power conservation state in response to no user being detected before the digital mirror display for more than a threshold amount of time.

19. A method of implementing a digital mirror, comprising:
accessing a real-time video image of a user positioned proximally in front of a display screen, the real-time video image being provided by a camera affixed to the display screen;
inverting the real-time video image prior to displaying the inverted real-time video image upon the display screen, the inverting being performed such that the displayed inverted real-time video image is a left-right mirror image of the real-time video image captured by the camera;
receiving verbal input from the user, the verbal input being captured by a microphone;
controlling a processor in communication with each of the display screen, the camera, and the microphone, the processor being operative to freeze the displaying of the inverted real-time video image in response to a certain verbal input being detected, wherein the processor causes a display of a still image of the user when the inverted real-time video image has been frozen, the still image being derived from the real-time video image.

20. The method of claim 19 wherein the processor is further operative to unfreeze the displaying of the inverted real-time video image in response to a particular verbal command being detected.

21. The method of claim 19 wherein the processor is further operative to perform an automatic state selection function, the automatic state selection function being performed in response to determining whether the user is detected in front of the display screen, the automatic state selection function comprising at least two operational states, the first state being a digital mirror state that is automatically engaged in response to the user being detected in front of the display screen, the second state being a digital picture frame state that is automatically engaged in response to the user not being detected in front of the display screen.

22. The method of claim 21 wherein the digital picture frame state is automatically engaged in response to the user not being detected in front of the display screen for at least a threshold amount of time.

23. A digital mirror system, comprising:
a digital mirror display to display substantially real-time video of a user standing in front of the digital mirror display;
a camera to capture the real-time video, wherein the camera is positioned within an area of the digital mirror display such that the camera captures a substantially frontal image of the user;
a processor in communication with the digital mirror display and the camera, the processor being operative to cause a representation of the real-time video captured by the camera to be displayed upon the digital mirror display, the processor being programmed to allow a plurality of selectively enabled operational states including a digital mirroring state and an alternate operational state, wherein the processor is programmed to automatically engage the alternate operational state in response to the user not being detected in front of the display screen for at least a threshold period of time.

24. The digital mirror system of claim 23 wherein the alternate operational state comprises a power-conservation state in which reduced power is consumed by the digital mirror display.

25. The digital mirror system of claim 23 wherein the alternate operational state comprises a digital picture frame state in which a pre-stored digital image is accessed from a memory and is displayed upon the digital mirror display.

26. The digital mirror system of claim 23 wherein the camera is mounted behind a display screen of the digital mirror display and captures the real-time video image by detecting light that passes through a plane of the display screen.
